(19) United States
(12) Patent Application Publication
(10) Pub. No.: US 2025/0071813 A1
(43) Pub. Date: Feb. 27, 2025

(54) Restricted Target Wake Time Service Period Extension

(71) Applicant: Ofinno, LLC, Reston, VA (US)

(72) Inventors: Kiseon Ryu, McLean, VA (US); Jeongki Kim, Fairfax, VA (US); Esmael Hejazi Dinan, McLean, VA (US)

(73) Assignee: Ofinno, LLC, Reston, VA (US)

(21) Appl. No.: 18/947,067

(22) Filed: Nov. 14, 2024

Related U.S. Application Data
(63) Continuation of application No. PCT/US2023/022315, filed on May 16, 2023.
(60) Provisional application No. 63/343,178, filed on May 18, 2022.

(51) Int. Cl. H04W 74/0816; H04L 5/00; H04W 28/02; H04W 74/08

(52) U.S. Cl. CPC H04W 74/0816; H04L 5/0053; H04W 28/0278; H04W 74/0866

(57) ABSTRACT

A station (STA) receives from an access point (AP) a frame indicating a start time and a wake duration of a restricted target wake time (r-TWT) service period (SP) of an r-TWT setup for the STA. The STA transitions to an awake state at or before the start time of the r-TWT SP. The STA receives, from the AP, during the r-TWT SP: a first frame comprising a traffic identifier (TID) associated with the r-TWT and having an end of service period (EOSP) field set to 0; or a trigger frame indicating an identifier of the STA. The STA transitions to a doze state, after expiration of the wake duration of the r-TWT SP, on condition of receiving, from the AP, after expiration of the wake duration of the r-TWT SP, a second frame comprising a TID associated with the r-TWT and having an EOSP field set to 1.

### CROSS-REFERENCE TO RELATED APPLICATIONS

This application is a continuation of International Application No. PCT/US2023/022315, filed May 16, 2023, which claims the benefit of U.S. Provisional Application No. 63/343,178, filed May 18, 2022, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of target wake time (TWT) operation.

FIG. 4 illustrates an example of TWT operation in an environment including an AP multi-link device (AP MLD) and a station multi-link device (STA MLD).

FIG. 5 illustrates an example TWT element which may be used to support individual TWT operation.

FIG. 6 illustrates an example TWT element which may be used to support restricted

TWT (r-TWT) operation.

FIG. 7 illustrates an example of individual TWT operation.

FIG. 8 illustrates an example of broadcast TWT operation.

FIG. 9 illustrates an example of TWT protection in individual TWT operation.

FIG. 10 illustrates an example of r-TWT operation.

FIG. 11 illustrates an example of trigger enabled r-TWT operation.

FIG. 12 illustrates an example medium access control (MAC) frame format.

FIG. 13 illustrates an example of r-TWT operation.

FIG. 14 illustrates an example of r-TWT operation according to an embodiment.

FIG. 15 illustrates an example of r-TWT operation according to an embodiment.

FIG. 16 illustrates an example of r-TWT operation according to an embodiment.

FIG. 17 illustrates an example of r-TWT operation according to an embodiment.

FIG. 18 illustrates an example Restricted TWT Traffic Info field according to an embodiment.

FIG. 19 illustrates an example process according to an embodiment.

FIG. 20 illustrates an example process according to an embodiment.

FIG. 21 illustrates an example process according to an embodiment.

FIG. 22 illustrates an example process according to an embodiment.

FIG. 23 illustrates an example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages are presented for example purposes only. The disclosed architecture is sufficiently flexible and configurable, such that it may be utilized in ways other than those shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers, and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

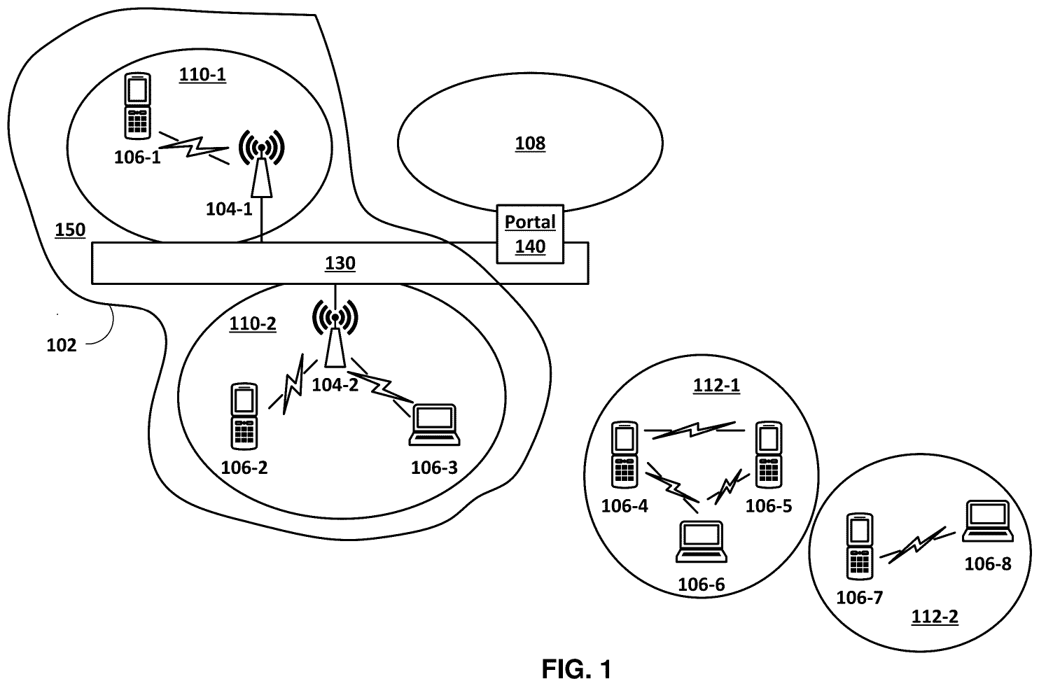

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHZ, 5 GHZ, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 320 MHz by bonding together multiple 20 MHz channels.

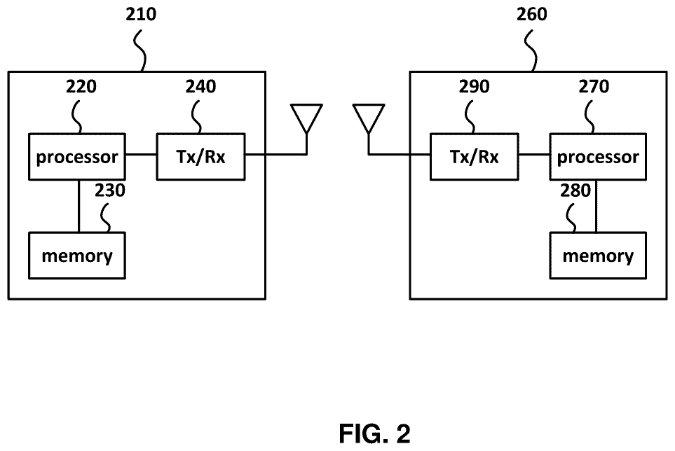

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

Target wake time (TWT), a feature introduced in the IEEE 802.11ah standard, allows STAs to manage activity in the BSS by scheduling STAs to operate at different times to reduce contention. TWTs may allow STAs to reduce the required amount of time that a STA utilizing a power management mode may be awake. TWTs may be individual TWTs or broadcast TWTs. Individual TWTs follow a negotiated TWT agreement between STAs. Broadcast TWTs are based on a schedule set and provided to STAs by an AP.

In an individual TWT, a STA that requests a TWT agreement is called a TWT requesting STA. The TWT requesting STA may be a non-AP STA for example. The STA that responds to the request is called a TWT responding STA. The TWT responding STA may be an AP for example. The TWT requesting STA is assigned specific times to wake up and exchange frames with the TWT responding STA. The TWT requesting STA may communicate wake scheduling information to the TWT responding STA. The TWT responding STA may transmit TWT values to the TWT requesting STA when a TWT agreement is established between them.

When explicit TWT is employed, the TWT requesting STA may wake up and perform a frame exchange. The TWT requesting STA may receive a next TWT information in a response from the TWT responding STA. When implicit TWT is used, the TWT requesting STA may calculate a next TWT by adding a fixed value to the current TWT value.

The TWT values for implicit TWT may be periodic. The TWT requesting STA operating with an implicit TWT agreement may determine a next TWT service period (TWT SP) start time by adding a value of a TWT wake interval associated with the TWT agreement to the value of the start time of the current TWT SP. The TWT responding STA may include the start time for a series of TWT SPs corresponding to a single TWT flow identifier of an implicit TWT agreement in a target wake time field of a TWT element. The TWT element may contain a value of ‘accept TWT’ in a TWT setup command field. The start time of the TWT SP series may indicate the start time of a first TWT SP in the series. Start times of subsequent TWT SPs may be determined by adding the value of the TWT wake interval to the start time of the current TWT SP. In an example, the TWT requesting STA, awake for an implicit TWT SP, may enter a doze state after the TWT SP has elapsed or after receiving an end of service period (EOSP) field equal to 1 from the TWT responding STA, whichever occurs first.

A TWT session may be negotiated between an AP and a STA. The TWT session may configure a TWT SP of DL and UL traffic between the AP and the STA. Expected traffic may be limited within the negotiated SP. The TWT SP may start at a specific time. The TWT SP may run for an SP duration. The TWT SP may repeat every SP interval.

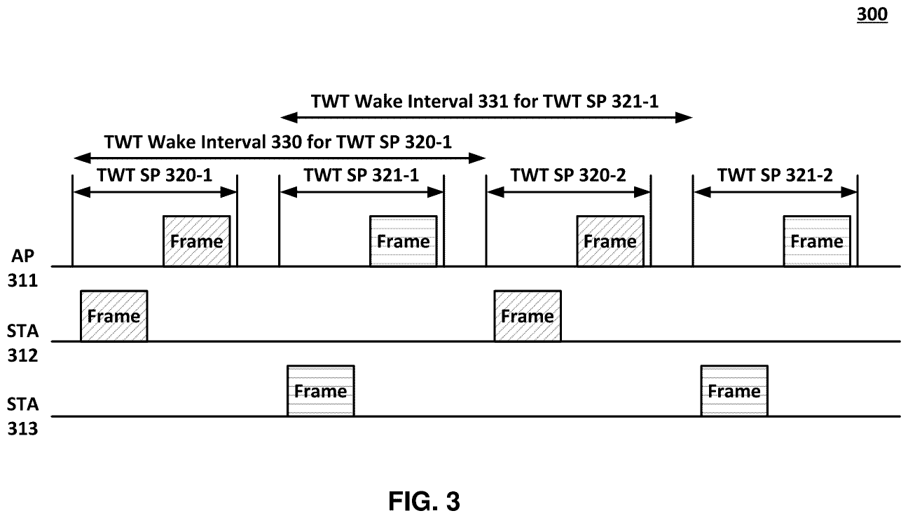

FIG. 3 illustrates an example 300 of TWT operation. As shown in FIG. 3, example 300 includes an AP 311, a STA 312, and a STA 313. AP 311 and STA 312 may establish a TWT SP 320. AP 311 and STA 313 may establish a TWT SP 321. TWT SP 320 and TWT SP 321 may repeat as shown in FIG. 3, such that TWT SP 320 may include a first TWT SP 320-1 and a second TWT SP 320-2, and such that TWT SP 321 may include a first TWT SP 321-1 and a second TWT SP 321-2.

AP 311 and STA 312 may exchange frames during first TWT SP 320-1. STA 312 may enter a doze state at the end of TWT SP 320-1 and may remain in the doze state until the start of second TWT SP 320-2. The start of second TWT SP 320-2 may be indicated by a TWT wake interval 330 associated with TWT SP 320. AP 311 and STA 312 may again exchange frames during second TWT SP 320-2.

Similarly, AP 311 and STA 313 may exchange frames during first TWT SP 321-1. STA 313 may enter a doze state at the end of first TWT SP 321-1 and may remain in the doze state until the start of second TWT SP 321-2. The start of second TWT SP 321-2 may be indicated by a TWT wake interval 331 associated with TWT SP 321. AP 311 and STA 313 may again exchange frames during second TWT SP 31-2.

In an awake state, a STA may be fully powered. The STA may transmit and/or receive a frame to/from an AP or another STA. In a doze state, a STA may not transmit and may not receive a frame to/from an AP or another STA.

An MLD is an entity capable of managing communication over multiple links. The MLD may be a logical entity and may have more than one affiliated station (STA). The MLD may have a single MAC service access point (MAC-SAP) to the LLC layer, which includes a MAC data service. An MLD may be an access point MLD (AP MLD) when a STA affiliated with the MLD is an AP STA (or an AP). An MLD may be a non-access point MLD (non-AP MLD) or STA MLD when a STA affiliated with the MLD is a non-AP STA (or a STA).

During negotiation of TWT agreements, a TWT requesting STA affiliated with a STA MLD and a TWT responding STA affiliated with an AP MLD may communicate multiple TWT elements. The TWT elements may comprise link ID bitmap subfields indicating different link(s) in a TWT setup frame. The TWT parameters provided by a TWT element may be applied to the respective link that is indicated in the TWT element.

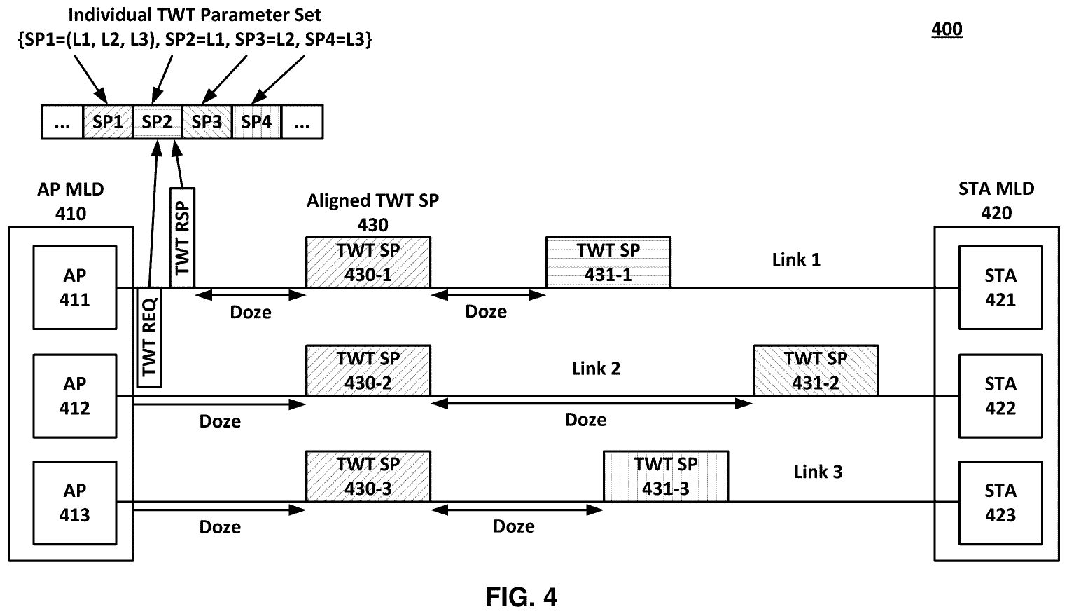

FIG. 4 illustrates an example 400 of TWT operation in a multi-link environment including an AP multi-link device (AP MLD) 410 and a STA multi-link device (STA MLD) 420. As shown in FIG. 4, AP MLD 410 may have three affiliated APs, AP 411, AP2 412, and AP3 413. In an example, AP 411, AP2 412, and AP3 413 may operate respectively on the 2.4 GHz band, the 5 GHz band, and the 6 GHz band. STA MLD 420 may have three affiliated STAs, STA 421, STA 422, and STA 423. In an example, STA 421, STA 422, and STA 423 may operate respectively on the 2.4 GHz band, the 5 GHz band, and the 6 GHz band. In an example, AP 411, AP2 412, and AP3 413 may be communicatively coupled via a first link (link 1), a second link (link 2), and a third link (link 3) respectively with STA 421, STA 422, and STA 423, respectively.

In an example, STA 421 may transmit a TWT request to AP 411. The TWT request may include three TWT elements. Each TWT element may indicate a respective link of links 1-3 and may request the setup of a TWT agreement for the indicated link. The three TWT elements may have different TWT parameters, such as target wake time (TWT). In response to the TWT request, AP 411 may transmit a TWT response to STA 421. The TWT response may include three TWT elements. Each TWT element may indicate a respective link of links 1-3 and may include a value of ‘accept TWT’ in a TWT setup command field.

Successful TWT agreement setup on links 1-3 establishes three TWT SPs with same or different TWT parameters on links 1-3 respectively. The target wake time field of the TWT element indicating a given link indicates the start time of the TWP SP for that link. The starting time may be indicated in reference to a time synchronization function (TSF) time of the link.

In example 400, initial TWT SPs 430-1, 430-2, and 430-3 of links 1-3 respectively may be aligned. TWT wake intervals associated with the TWT agreements of links 1-3 respectively may be set differently. As such, second TWT SPs 431-1, 431-2, and 431-3 of links 1-3 respectively may not be aligned. STA 421, STA 422, and STA 423 may enter a doze state between the end of initial TWT SPs 430-1, 430-2, and 430-3, respectively, and the start of second TWT SPs 431-1, 431-2, 431-3, respectively.

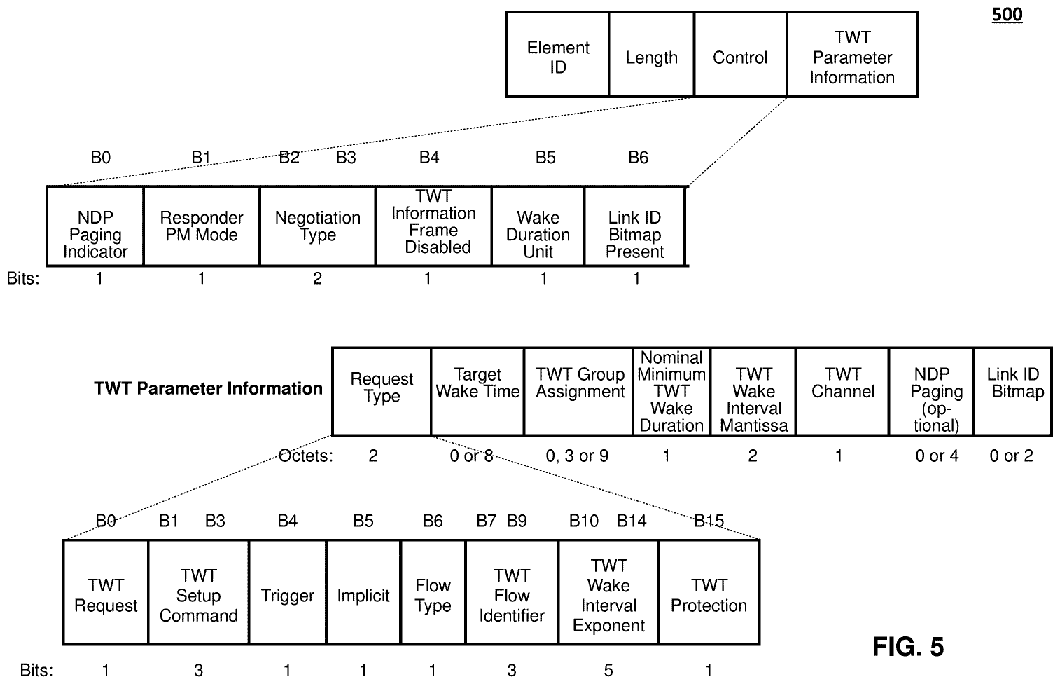

FIG. 5 illustrates an example target wake time (TWT) element 500 which may be used to support individual TWT operation.

In an example, an AP and a STA may use TWT element 500 to negotiate a TWT agreement. The AP and/or the STA may transmit TWT element 500 in an individually addressed management frame. The management frame may be of the type action, action no ack, (re) association request/response, and probe request response, for example.

The TWT schedule and parameters may be provided during a TWT setup phase. Renegotiation/changes of TWT schedules may be signaled via individually addressed frames that contain the updated TWT schedule/parameters. The frames may be management frames as described above or control or data frames that carry a field containing the updated TWT schedule/parameters.

Referring to FIG. 5, TWT element 500 includes an element ID field, a length field, a control field, and a TWT parameter information field.

The element ID field (e.g., 1 octet in length) may indicate that information element 500 is a TWT element. The length field (e.g., 1 octet) may indicate the length of TWT element 500 starting from the control field until an end of TWT element 500. The end of TWT element 500 may be the end of a TWT Channel field or the end of a Link ID bitmap field of the TWT parameter information field.

The TWT parameter information field may include a request type field (e.g., 2 octets), a target wake time field (e.g., 8 octets or less), a TWT group assignment field (e.g., 9, 3, 2, or 0 octets), a nominal minimal TWT wake duration field (e.g., 1 octet), a TWT wake interval mantissa (e.g., 2 octets), a TWT channel field (e.g., 1 octet), an optional NDP paging field (e.g., 0 or 4 octets), and/or a Link ID bitmaps field (e.g., 0 or 2 Octets).

The request type field may indicate a type of TWT request. The request type field may include a TWT request field (e.g., 1 bit), a TWT setup command field (e.g., 3 bits), a trigger field (e.g., 1 bit), an implicit field (e.g., 1 bit), a flow type (e.g., 1 bit), a TWT flow identifier (e.g., 3 bits), a TWT wake interval exponent (e.g., 5 bits), and/or a TWT protection field (e.g., 1 bit).

The TWT request field may indicate whether the TWT element 500 represents a request. If TWT request field has a value of 1, then the TWT element 500 may represent a request to initiate TWT scheduling/setup.

The TWT setup command field may indicate a type of TWT command. In a TWT request, the type of TWT command indicated may be: a request TWT (the TWT responding STA specifies the TWT value; e.g., field set to 0), a suggest TWT (the TWT requesting STA suggests a TWT value; e.g., field set to 1), and a demand TWT (the TWT requesting STA demands a TWT value; e.g., field set to 2).

In a TWT response, the type of TWT command indicated may be: TWT grouping (the TWT responding STA suggests TWT group parameters that are different than the suggested or demanded TWT parameters of the TWT requesting STA; e.g., field set to 3), accept TWT (the TWT responding STA accepts the TWT request with the TWT parameters indicated by the TWT requesting STA; e.g. field set to 4), alternate TWT (the TWT responding STA suggests TWT parameters that are different than the parameters suggested or demanded by the TWT requesting STA; e.g., field set to 5), dictate TWT (the TWT responding STA demands TWT parameters that are different than the parameters suggested or demanded by the TWT requesting STA; e.g., field set to 6), or reject TWT (the TWT responding STA rejects the TWT setup; e.g. field set to 7).

In a TWT response, the TWT command may also indicate an unsolicited response or a broadcast TWT. An unsolicited TWT response is an individually addressed frame that is intended for a specific STA. An unsolicited TWT response may be followed by an ACK frame from the STA receiving the unsolicited TWT response. A broadcast TWT may be intended for multiple STAs and may be carried in a broadcast frame such as, for example, a beacon frame. A broadcast TWT may not be acknowledged by receiving STAs.

An unsolicited TWT response may be used a TWT responding STA to demand that a recipient follow a TWT schedule contained in the TWT element. In an embodiment, an unsolicited TWT response may have the TWT request field set to 0 and a value of ‘dictate TWT’ in the TWT setup command field. A broadcast TWT response may be used by a TWT responding STA to schedule a TWT for any STA that receives and decodes the TWT element.

In certain embodiments, a TWT element, such as TWT element 500, may contain TWT parameter sets for multiple TWT negotiations or indications as described herein. As such, the TWT element may include multiple instances of the Control and the TWT parameter information fields. The TWT flow identifier of the request type field indicates the TWT negotiation which parameters are carried by the TWT parameter information field.

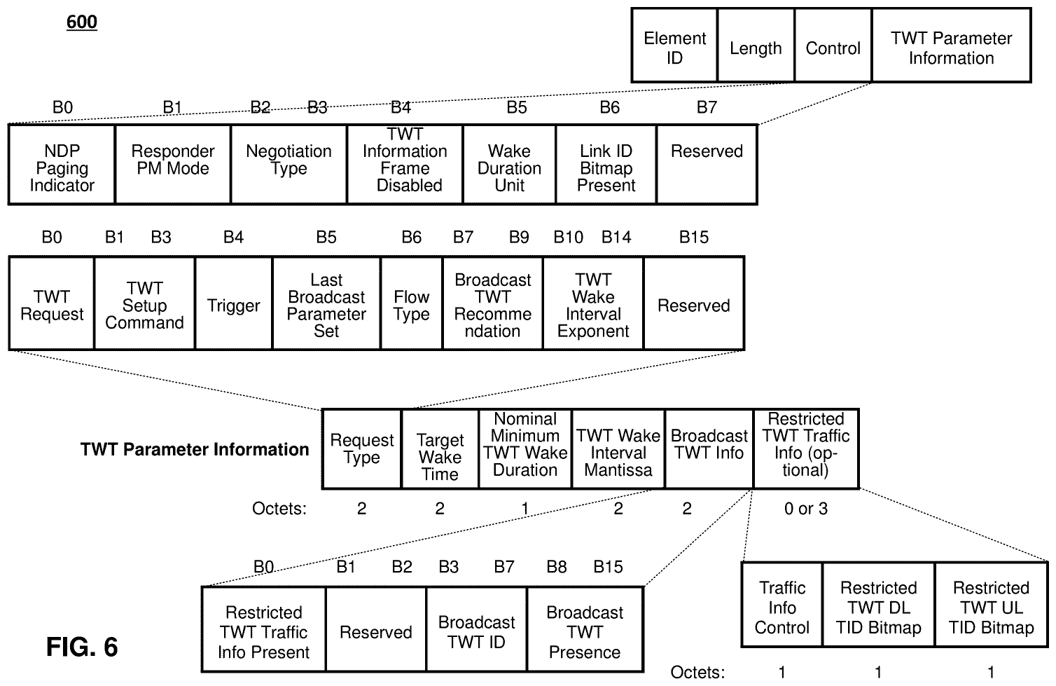

FIG. 6 illustrates an example target wake time (TWT) element 600 which may be used to support restricted TWT (r-TWT) operation. For r-TWT, TWT element 600 may be transmitted in a broadcast management frame, which can be a beacon frame, a TIM broadcast frame, a probe response frame, etc. In this embodiment, TWT element 600 provides non-negotiated TWT schedules (e.g., broadcast TWT schedules).

As shown, TWT element 600 includes an element ID field, a length field, a control field, and a TWT parameter information field.

The element ID field (e.g., 1 octet in length) may indicate that information element 600 is a TWT element. The length field (e.g., 1 octet) may indicate the length of TWT element 600 starting from the control field until an end of TWT element 600. The end of TWT element 600 may be the end of a broadcast TWT info field or the end of a r-TWT traffic info field of the TWT parameter information field.

The TWT parameter information field may include a request type field, a target wake time field (e.g., 2 octets), a nominal minimal TWT wake duration field (e.g., 1 octet), a TWT wake interval mantissa (e.g., 2 octets), a broadcast TWT info field (e.g., 2 octets), and an optional r-TWT traffic info field (e.g., 0 or 3 octets).

The request type field may include, among other fields, a TWT request field, a flow type field, and a TWT wake interval exponent field.

The TWT request field indicates whether TWT element 600 is a request. If the TWT request field has a value of 0, then TWT element 600 may represent a response to a request to initiate TWT scheduling/setup (solicit TWT), an unsolicited TWT response, and/or a broadcast TWT message.

The TWT wake interval represents the average time that a TWT requesting STA or a TWT scheduled STA expects to elapse between successive TWT SP start times of a TWT schedule. The TWT wake interval exponent field indicates a (base 2) exponent used to calculate the TWT wake interval in microseconds. In an embodiment, the TWT wake interval is equal to: (TWT wake interval mantissa)×2 (TWT Wake Interval Exponent). The TWT wake interval mantissa value is indicated in microseconds, base 2 in a TWT wake interval mantissa field of the TWT parameter information field.

The nominal minimum TWT wake duration field may indicate the minimum amount of time (in the unit indicated by a wake duration unit subfield of the control field) that a TWT requesting STA or a TWT scheduled STA is expected to be awake to complete frame exchanges for the period of the TWT wake interval.

The flow type field, in a TWT response that successfully set up a TWT agreement between a TWT requesting STA and a TWT responding STA, may indicate a type of interaction between the TWT requesting STA and the TWT responding STA within a TWT SP of the TWT agreement. A flow type field equal to 0 may indicate an announced TWT. In an announced TWT, the TWT responding STA may not transmit a frame to the TWT requesting STA within a TWT SP until the TWT responding STA receives a PS-Poll frame or a QoS Null frame from the TWT requesting STA. A flow type field equal to I may indicate an unannounced TWT. In an unannounced TWT, the TWT responding STA may transmit a frame to the TWT requesting STA within a TWT SP before it has received a frame from the TWT requesting STA.

Within a TWT element that includes a TWT setup command value of ‘request TWT’, ‘suggest TWT’, or ‘demand TWT’, a broadcast TWT ID may indicate a specific broadcast TWT in which the TWT requesting STA is requesting to participate. Within a TWT element that includes a TWT setup command value of ‘accept TWT’, ‘alternate TWT’, ‘dictate TWT’, or ‘reject TWT’, a broadcast TWT ID may indicate a specific broadcast TWT for which the TWT responding STA is providing TWT parameters. The value 0 in the broadcast TWT ID subfield may indicate the broadcast TWT whose membership corresponds to all STAs that are members of the BSS corresponding to the BSSID of the management frame carrying the TWT element and that is permitted to contain trigger frames with random access resource units for unassociated STAs. The Broadcast TWT ID subfield in a r-TWT Parameter set field is always set to a nonzero value.

A broadcast TWT element 600 that contains a r-TWT parameter set is also referred to as a r-TWT element. A r-TWT traffic info present subfield of the broadcast TWT info field may be set to 1 to indicate the presence of the r-TWT traffic info field in TWT element 600. The r-TWT traffic info field is present in a r-TWT parameter set field when the r-TWT traffic info present subfield is set to 1.

The r-TWT traffic info field may include a traffic info control field, a r-TWT DL TID bitmap field, and a r-TWT UL TID bitmap field.

The traffic info control field may include a DL TID bitmap valid subfield and an UL TID bitmap valid subfield. The DL TID bitmap valid subfield indicates if the r-TWT DL TID bitmap field has valid information. When the value of the DL TID bitmap valid subfield is set to 0, it may indicate that DL traffic of TIDs is identified as latency sensitive traffic, and the r-TWT DL TID bitmap field is reserved. The UL TID bitmap valid subfield may indicate if the r-TWT UL TID bitmap field has valid information. When the value of the UL TID bitmap valid subfield is set to 0, it may indicate that UL traffic of TIDs is identified as latency sensitive traffic, and the r-TWT UL TID bitmap field is reserved.

The r-TWT DL TID bitmap subfield and the r-TWT UL TID bitmap subfield may specify which TID(s) are identified by the TWT scheduling AP or the TWT scheduled STA as latency sensitive traffic streams in a downlink and an uplink direction, respectively. A value of 1 at bit position k in the bitmap indicates that TID k is classified as a latency sensitive traffic stream. A value of 0 at bit position k in the bitmap indicates that TID k is not classified as a latency sensitive traffic stream.

An individual target wake time (TWT) may be a specific time or set of times negotiated between two individual stations (e.g., a STA and another STA, or a STA and an AP, etc.) at which the stations may be awake to exchange frames during a service period (SP) of the TWT.

In trigger-enabled TWT, an AP may transmit a trigger frame for scheduling uplink multi-user transmissions from one or more STAs using uplink OFDMA (orthogonal frequency division multiple access) and/or uplink MU-MIMO (multi-user multiple input multiple output) during a trigger-enabled TWT SP. A TWT STA that receives the trigger frame from the AP may transmit a frame to the AP through a resource indicated in the trigger frame during the trigger-enabled TWT SP.

In non-trigger-enabled TWT, an AP may not be required to transmit a trigger frame to schedule uplink multi-user transmissions from one or more STAs during a non-trigger-enabled TWT SP.

In announced TWT, a STA may transmit a frame (e.g., a PS-Poll frame or a QoS null frame) to the AP to retrieve a downlink buffered data from the AP during a TWT SP. In unannounced TWT, an AP may transmit downlink data to a TWT STA without receiving a frame (e.g., a PS-Poll frame, or a QoS null frame) from the TWT STA during a TWT SP.

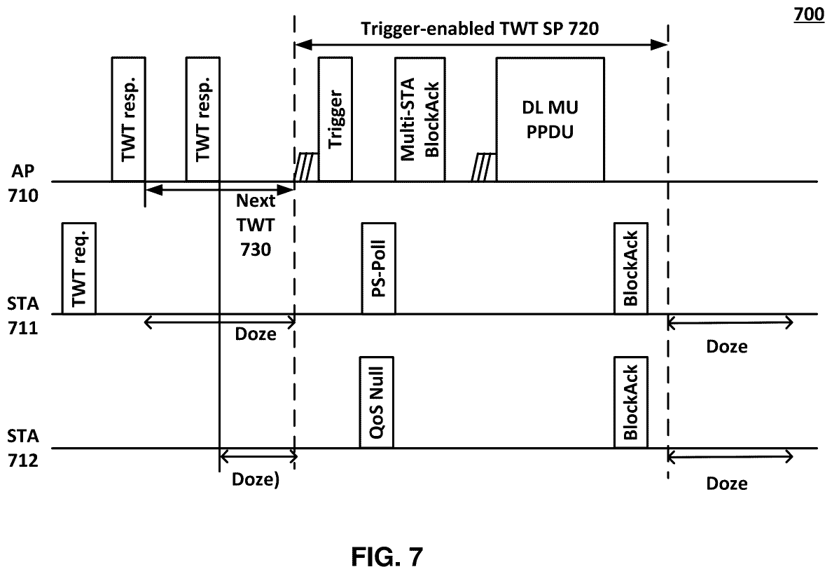

FIG. 7 illustrates an example 700 of individual TWT operation. As shown in FIG. 7, example 700 includes an AP 710, a STA 711, and a STA 712. In an example, AP 710 may be a TWT responding STA and STA 711 and STA 712 may be TWT requesting STAs.

In an example, STA 711 may transmit a TWT request to AP 710 to setup a first trigger-enabled TWT agreement. STA 711 may set a trigger field of the TWT request to 1 to indicate that it is requesting a trigger-enabled TWT. AP 710 may accept the first TWT agreement with STA 711. AP 710 may confirm the acceptance in a TWT response sent to STA 711. The TWT response may indicate a next TWT 730, which indicates the time until a next TWT SP 720 according to the first TWT agreement.

In an example, AP 710 may transmit an unsolicited TWT response to STA 712 to set up a second trigger-enabled TWT agreement with STA 712 without receiving a TWT request from STA 712. The first and second TWT agreements may be set up as announced TWTs.

After the setup of the TWT agreements, STA 711 and STA 712 may enter a doze state until the start of TWT SP 720. During trigger-enabled TWT SP 720, AP 710 may transmit a trigger frame. STA 711 and STA 12 may respond to the trigger frame by indicating that they are in awake state. In an example, STA 711 may transmit a power save poll (PS-Poll) frame. The PS-Poll frame may comprise a BSSID (receiver address: RA) field set to an address of AP 710 and a transmitter address (TA) field set to an address of STA 711. In an example, STA 712 may transmit a QoS null frame in response to the trigger frame. The QoS null frame may comprise a MAC header (e.g., a frame control field, a duration field, address fields, a sequence control field, QoS control field) without a frame body.

In response to the PS-Poll frame and the QoS null frame, AP 710 may transmit a multi-STA Block Ack (M-BA) frame. The M-BA frame may include acknowledgement information associated with the PS-Poll frame and the QoS null frame received from STAs 711 and 712 respectively. Subsequently, STA 711 and STA 712 may receive downlink bufferable units (DL BUs) from AP 710. The DL BUs may include a medium access control (MAC) service data unit (MSDU), an aggregate MAC service data unit (A-MSDU), and/or a bufferable MAC management protocol data unit (MMPDU). STA 711 and STA 712 may transmit Block Ack (BA) frames in response to the DL BUs. At the end of the TWT SP 720, STA 711 and STA 712 may return to a doze state.

A STA may execute individual TWT setup exchanges. The STA may not transmit frames to an AP outside of negotiated TWT SPs. The STA may not transmit frames that are not contained within high efficiency trigger-based physical protocol data units (HE TB PPDUs) to the AP within trigger-enabled TWT SPs. A HE TB PPDU may be transmitted by a STA based on receiving a trigger frame triggering uplink multi-user transmissions.

The AP of a trigger-enabled TWT agreement may schedule for transmission a trigger frame for a STA within the trigger-enabled TWT SP. The STA may transmit an HE TB PPDU as a response to the trigger frame sent during the trigger-enabled TWT SP. A STA that is in power save (PS) mode may include a PS-Poll frame or a QoS null frame in the HE TB PPDU if the TWT is an announced TWT, to indicate to the AP that the STA is currently in the awake state. The AP that receives the PS-Poll frame or the QoS Null frame or any other indication from an STA in PS mode, may deliver to the STA as many buffered BUs as are available at the AP during the TWT SP.

A broadcast target wake time (TWT) may be a specific time or set of times broadcast by an AP to one or more STAs at which the STAs may be awake to exchange frames with the AP during a SP of the TWT.

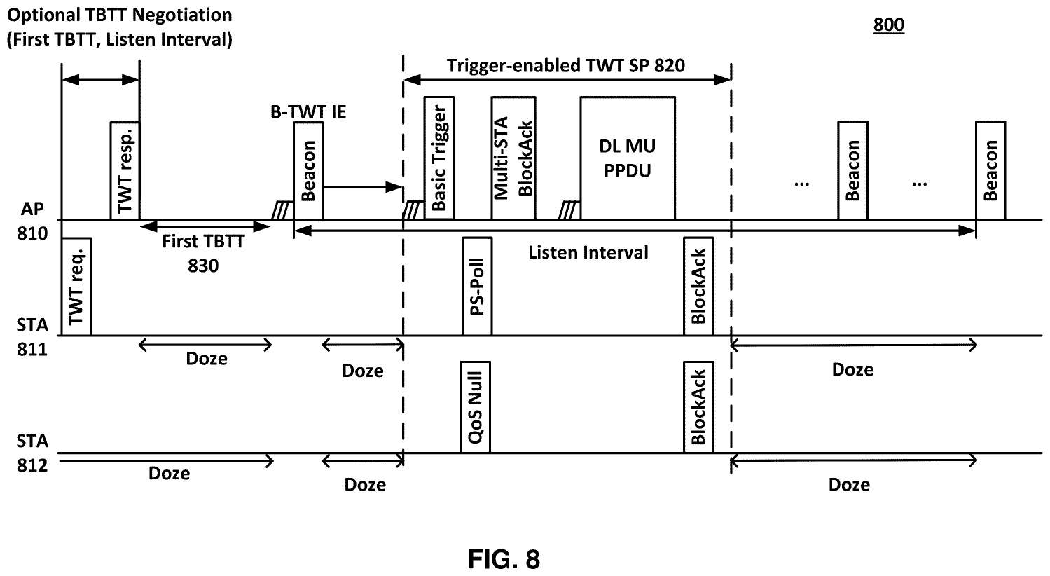

FIG. 8 illustrates an example 800 of broadcast TWT operation. As shown in FIG. 8, example 800 includes an AP 810, a STA 811, and a STA 812. In an example 800, AP 810 may be a TWT scheduling AP and STA 811 and STA 812 may be TWT scheduled STAs.

In an example, AP 810 may include a broadcast TWT element in a beacon frame that indicates a broadcast TWT SP 820. During the broadcast TWT SP 820, AP 810 may transmit trigger frames or DL BUs to STA 811 and STA 812. Beacon frames may be sent by AP 810 periodically at target beacon transmission times (TBTTs). The number of time units (TUs) between consecutive TBTTs is called the beacon interval. A TU is equal to 1024 microseconds.

In an example, STA 811 and STA 812 may enter a doze state until the first target beacon transmission time (TBTT). STA 811 and STA 812 may wake up to receive the beacon frame at the first TBTT to determine the broadcast TWT. Upon reception of a broadcast TWT element in a beacon frame, STA 811 and STA 812 may re-enter the doze state until the start of trigger-enabled TWT SP 820.

During trigger-enabled TWT SP 820, AP 810 may transmit a basic trigger frame to STA 811 and STA 812. STA 811 may indicate that it is awake by transmitting a PS-Poll, and STA 812 may indicate that it is awake by transmitting a QoS null frame in response to the basic trigger frame. Subsequently, STA 811 and STA 812 may receive DL BUs from AP 810. STA 811 and STA 812 may return to the doze state outside of the TWT SP 720.

In an example, a STA that intends to operate in power save mode may negotiate a wake TBTT and a wake interval with the AP. For example, as shown in FIG. 8, STA 811 may transmit a TWT request to AP 810 that identifies a wake TBTT of the first beacon frame and a wake interval between subsequent beacon frames. AP 810 may respond with a TWT response to the TWT request confirming the wake TBTT and wake interval. After successfully completing the negotiation, STA 811 may enter a doze state until a first negotiated wake TBTT 830. STA 811 may be in an awake state to listen to the beacon frame transmitted at first negotiated wake TBTT 830. If STA 811 receives a beacon frame from AP 810 at or after TBTT 830, STA 811 may return to the doze state until the next wake TBTT unless a traffic indication map (TIM) element in a beacon frame includes a positive indication for STA 811. The STA 811 may return to the doze state after a nominal minimum TBTT wake duration time has elapsed from the TBTT start time.

A Network Allocation Vector (NAV) is an indicator, maintained by a station (STA), of time periods when transmission onto the wireless medium (WM) may not be initiated by the STA regardless of whether the clear channel assessment (CCA) function of the STA senses that the WM is busy. A STA that receives at least one valid frame in a PSDU may update its NAV with the information from any valid duration field in the PSDU. The STA may update the NAV when a value of the received duration field is greater than the current NAV value of the STA.

A TWT protection is a mechanism employed to protect a TWT session from external STA transmissions. During a TWT SP configured to protect the TWT session, a STA that initiates a transmission opportunity (TXOP) to transmit a frame may transmit a request to transmit (RTS) frame or a clear to transmit (CTS) frame to protect the TWT session by setting the NAV of other STAs based on receiving of the RTS frame and/or the CTS frame. The RTS frame may comprise a frame control field, a duration field, a receiver address (RA) field, a transmitter address (TA) field, and a frame check sequence (FCS) field. The CTS frame may comprise a frame control field, a duration field, a receiver address (RA) field, and a frame check sequence (FCS) field.

The TWT protection field in a TWT element may indicate whether a TWT is protected or unprotected. A TWT requesting STA may set the TWT protection field to I to request the TWT responding STA to provide protection for the set of TWT SPs. A TWT protection field equal to I may indicate to use a NAV protection mechanism to protect access to the medium during the corresponding TWT SPs.

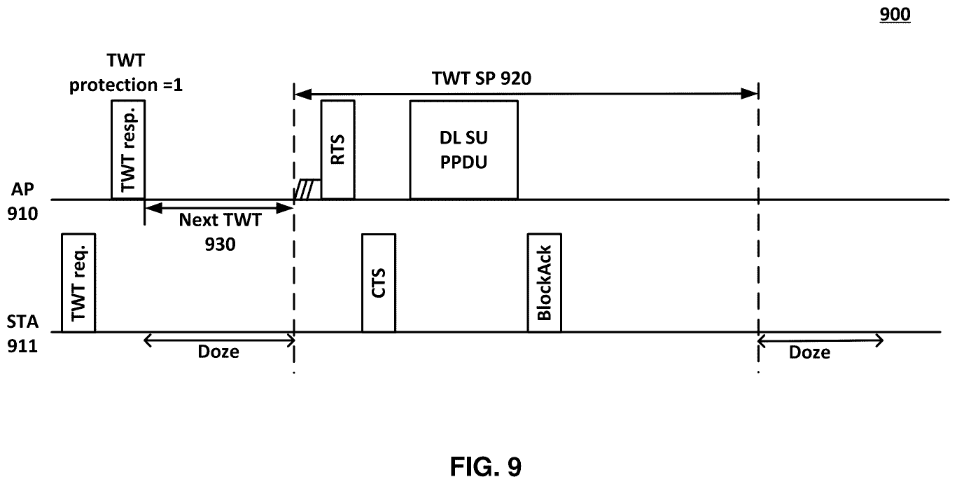

FIG. 9 illustrates an example 900 of TWT protection in individual TWT operation. As shown in FIG. 9, example 900 includes an AP 910 and a STA 911.

In an example, AP 910 may set the TWT protection field to 1 in a TWT response frame to protect the TWT SPs using a NAV protection mechanism. Upon reception of the TWT response frame, STA 911 may enter a doze state until the next TWT 930. AP 910 that has set the TWT protection field to I may transmit a NAV setting frame at the start of the TWT SP 920. For example, the NAV setting frame may be an RTS frame or a CTS frame.

A STA that receives the NV setting frame and that is not scheduled to access the medium during the TWT SP 920 may set their NAV according to the NAV setting frame. The STA may not access the medium for the specified amount of time in the NAV setting frame.

STA 911 may be scheduled to access the medium during the TWT SP 920. STA 911 may respond to the RTS frame with a CTS frame. Upon receiving the CTS frame, AP 910 may transmit a downlink frame to STA 911. STA 911 may respond to the downlink frame with a BA frame. When the TWT SP 920 ends, STA 911 may return to the doze state.

Traffic originating from many real time applications may have stringent latency requirements (e.g., very low average latency, worst-case latency on the order of a few to tens of milliseconds, and small jitter). Such traffic is referred to as latency sensitive traffic. R-TWT operation may allow an AP to use enhanced medium access protection and resource reservation mechanisms to provide more predictable latency, reduced worst case latency, and/or reduced jitter, with higher reliability for latency sensitive traffic.

Using TWT, a STA may negotiate awake periods with an AP to transmit and receive data packets. The STA may save power the rest of the time as the STA may remain in a doze state. TWT operation may thus lead to low power consumption for the participating STAs. TWT operation may also reduce the contention level and may support a collision-free and deterministic operation when STAs are distributed over different TWT sessions.

Using r-TWT (r-TWT) operation, an AP may allocate r-TWT SP(s) that may be used for transmission of data frames with latency sensitive traffic by the AP and one or more STAs. Traffic identifiers (TIDs) of latency sensitive traffic may be indicated in a broadcast frame (e.g., beacon frame, probe response frame, etc.) sent by the AP. The TIDs may be indicated in a r-TWT DL TID bitmap and/or a r-TWT UL TID bitmap of a r-TWT traffic info field of a TWT element. A data frame with a TID that is not identified as latency sensitive traffic may not be transmitted during an r-TWT SP.

A r-TWT scheduling AP, referred to as an r-TWT scheduling AP, may be an extremely high throughput AP (EHT AP) that supports r-TWT operation. A r-TWT scheduled STA, referred to as an r-TWT scheduled STA, is a non-AP EHT STA that supports r-TWT operation. When a r-TWT agreement is set up, the EHT AP may announce a r-TWT SP (r-TWT SP) schedule information in a broadcast TWT element. The broadcast TWT element may be contained in a management frame such as a beacon frame or a probe response frame.

The EHT AP may schedule a quiet interval that overlaps with a r-TWT SP. The quiet interval may have a duration of 1 TU. The quiet interval may start at the same time as the corresponding r-TWT SP. A quiet interval may be scheduled by including a quiet element in a beacon frame and/or a probe response frame. Legacy STAs may not be permitted to initiate a frame transmission during the quiet interval overlapping with the r-TWT SP.

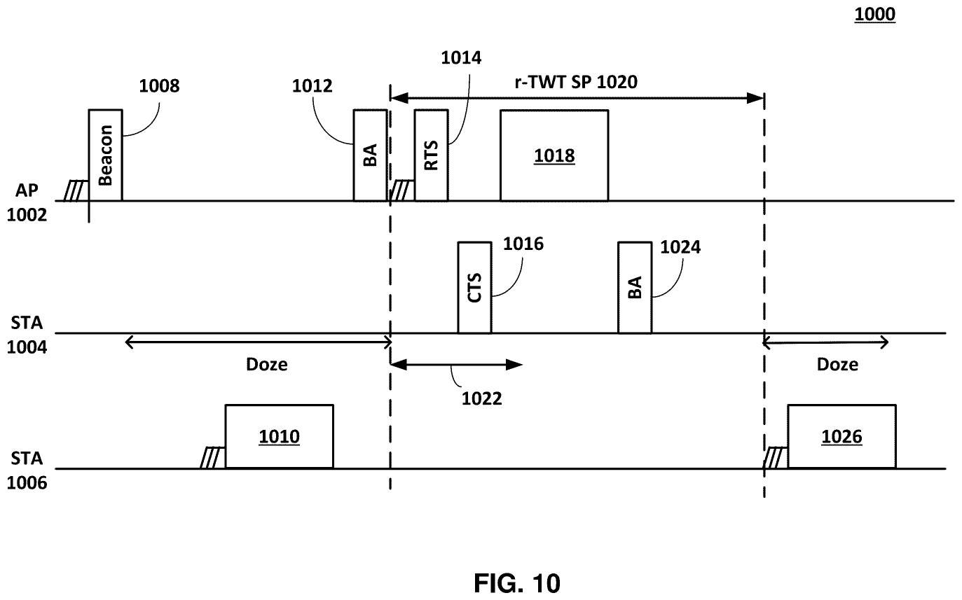

FIG. 10 illustrates an example 1000 of r-TWT operation. As shown in FIG. 10, example 1000 includes an AP 1002, a STA 1004, and a STA 1006.

In an example, an r-TWT agreement (hereinafter “r-TWT”) may be setup between AP 1002 and STA 1004. The r-TWT may not include STA 1006. For example, STA 1006 may be a legacy STA or an EHT STA not scheduled by AP 1002 as part of the r-TWT agreement.

In an example, AP 1002 may transmit a beacon frame 1008 including a TWT element that indicates an r-TWT SP 1020 of the setup r-TWT and TIDs allowed to be transmitted during the setup r-TWT. Beacon frame 1008 may also include a quiet element indicating a quiet interval 1022.

Upon receiving beacon frame 1008, STA 1004 may enter a doze state and may remain in the doze state until the start of r-TWT SP 1020. STA 1006, which is not scheduled by AP 1002 for r-TWT SP 1020, may transmit a data frame 1010 after receiving beacon frame 1008. However, STA 1006 must end its transmission before the start of r-TWT SP 1020. AP 1002 may transmit a BA frame 1012 in response to data frame 1010.

During r-TWT SP 1020, AP 1002 and STA 1004 may exchange an RTS frame 1014 and a CTS frame 1016. Subsequently, AP 1002 may send a data frame 1018 to STA 1004. Data frame 1018 includes traffic having a TID from among the TIDs indicated as permitted to transmit during r-TWT SP 1020 in beacon frame 1008. STA 1004 may respond with a BA frame 1024 to data frame 1018.

STA 1006 may not access the medium at least during quiet interval 1022 indicated in beacon frame 1008. When quiet interval 1022 or r-TWT SP 1020 ends, STA 1006 may resume transmission by transmitting a data frame 1026. STA 1004 may return to the doze state at the end of r-TWT SP 1020.

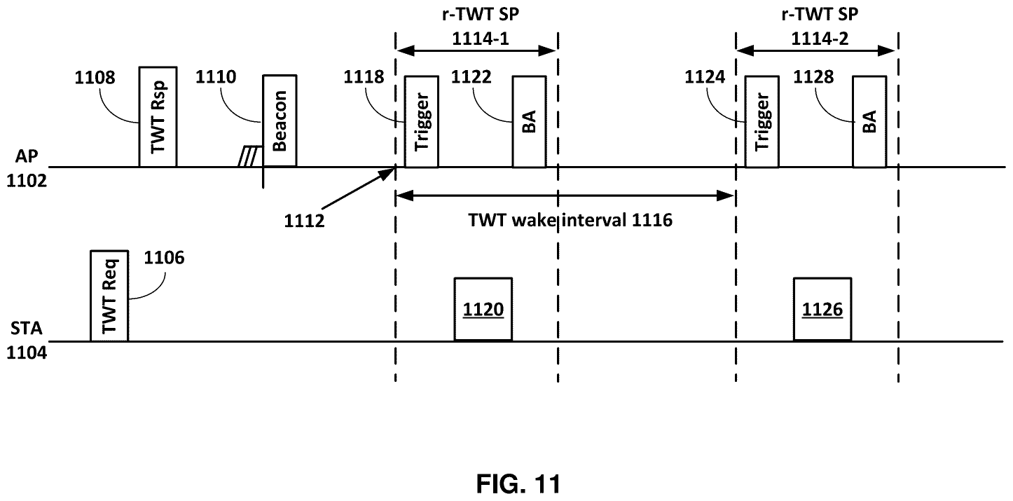

FIG. 11 illustrates an example 1100 of trigger enabled r-TWT operation. As shown in FIG. 11, example 1100 includes an AP 1102 and a STA 1104.

In an example, STA 1104 may transmit a TWT setup request frame 1106 to AP 1102. TWT setup request frame 1106 may include a first broadcast TWT element. The first broadcast TWT element may include a first r-TWT parameter set for a requested r-TWT.

In an example, the requested r-TWT may be a trigger-enabled r-TWT. In an embodiment, a trigger field of the first r-TWT parameter set may be set to 1 to indicate that the requested r-TWT is trigger-enabled.

The first r-TWT parameter set may include first DL/UL bitmaps that indicate respectively first DL/UL TIDs. The first DL/UL TIDs may correspond to DL/UL traffic that may be transmitted during the requested r-TWT. The DL/UL traffic identified by the first DL/UL TIDs may represent latency sensitive traffic.

The first r-TWT parameter set may include a broadcast TWT (b-TWT) identifier identifying a b-TWT membership group associated with the requested r-TWT. The b-TWT identifier may have a value greater than 0.

In response to TWT setup request frame 1106, AP 1102 may respond with a TWT setup response frame 1108. TWT setup response frame 1108 may include a second broadcast TWT element. The second broadcast TWT element may include a second r-TWT parameter set for the requested r-TWT.

The second r-TWT parameter set may include similar parameters as contained in the first r-TWT parameter set. The values of the parameters of the second r-TWT parameter set may be the same or different than the values of the parameters of the first r-TWT SP. In other words, AP 1102 may modify in the second r-TWT parameter set one or more of the parameter values of the first r-TWT parameter set. For example, AP 1102 may modify the DL/UL TIDS that may be transmitted during the r-TWT.

In an embodiment, the second r-TWT parameter set may include the b-TWT identifier identifying the b-TWT membership group associated with the requested r-TWT.

Upon a successful exchange of TWT setup request frame 1106 and TWT setup response frame 1108, the requested r-TWT is setup between AP 1102 and STA 1104. STA 1104 is considered a member r-TWT scheduled STA of the r-TWT. In other words, STA 1104 may be allowed to transmit during service periods of the setup r-TWT. Another STA (not shown in FIG. 11) may join the setup r-TWT by exchanging TWT setup request and response frames with AP 1102. AP 1102 may also add another STA (not shown in FIG. 11) to the setup r-TWT by transmitting a TWT setup response frame to the STA.

Subsequently, AP 1102 may transmit a beacon frame 1110 including a broadcast TWT element. The broadcast TWT element may indicate the b-TWT identifier associated with the setup r-TWT and include a TWT parameter set for the setup r-TWT. The TWT parameter set may include a TWT schedule for the setup r-TWT.

As shown in FIG. 11, the TWT schedule may determine a start time 1112 of a first r-TWT SP 1114-1 of the setup r-TWT as well as start times of one or more subsequent r-TWT SP(s) of the setup r-TWT (e.g., r-TWT SP 1114-2). The TWT schedule may be indicated, without limitation, using a target wake time field and a TWT wake interval mantissa field of the broadcast TWT element. The target wake time value may indicate start time 1112 of r-TWT SP 1114-1. The TWT wake interval mantissa value may be used to determine a TWT wake interval 1116. TWT wake interval 1116 represents the amount of time separating successive r-TWT SPs of the setup r-TWT (e.g., the time between the start time 1112 of r-TWT SP 1114-1 and a start time of r-TWT SP 1114-2).

The TWT parameter set in beacon frame 1110 may also indicate a nominal minimum TWT wake duration. The nominal minimum TWT wake duration may indicate a duration of a service period (e.g., r-TWT SP 1114-1, r-TWT SP 1114-2) of the setup r-TWT.

In an example, STA 1104 may enter a doze state after receiving beacon frame 1110. STA 1104 may wake up at start time 1112 of r-TWT SP 1114-1 to exchange data frames with AP 1102.

As shown in FIG. 11, AP 1102 may transmit a trigger frame 1118 at the start of r-TWT SP 1114-1. Trigger frame 1118 triggers STA 1104 to transmit buffered traffic having a TID from among the TIDs permitted for transmission during the setup r-TWT (e.g., latency sensitive traffic). In example 1100, STA 1104 responds to trigger frame 1118 by transmitting a data frame 1120 with latency sensitive traffic. AP 1102 may acknowledge data frame 1120 by transmitting a BA frame 1122.

STA 1104 may return to the doze state at the end of r-TWT SP 1114-1 and may remain in the doze state until the start of r-TWT SP 1114-2. During r-TWT SP 1114-2, similar frame exchanges may take place. Particularly, AP 1102 may transmit a trigger frame 1124, which triggers STA 1104 to transmit a data frame 1126. AP 1102 may acknowledge data frame 1126 by transmitting a BA frame 1128.

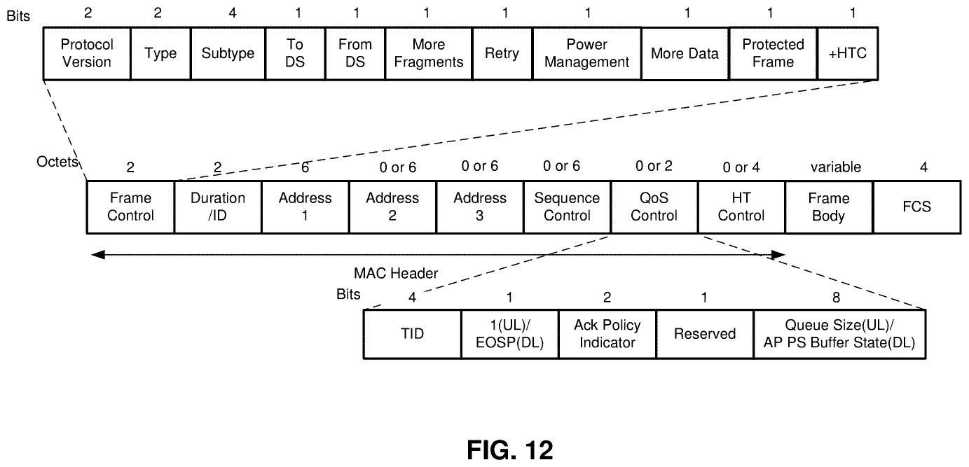

FIG. 12 illustrates an example MAC frame format 1200. As further described below, MAC frame format 1200 may be used in some of the frames transmitted/received according to embodiments of the present disclosure. As shown in FIG. 12, a MAC frame in accordance with MAC frame format 1200 includes a MAC header, a variable length frame body, and a frame check sequence (FCS).

The MAC header includes a frame control field, an optional duration/ID field, address fields, an optional sequence control field, an optional QoS control field, and an optional HT control field.

The frame control field includes the following subfields: protocol version, type, subtype, “To DS”, “From DS”, “More Fragments”, retry, power management, “More Data, protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS data frame, which is a data frame that contains a QoS control field in its MAC header. The second MSB of the subtype field, bit 6 (B6) of the frame control field, when set to 1 in data subtypes, indicates a data frame that contain no frame body field.

The “To DS” subfield indicates whether a data frame is destined to the distribution system (DS). The “From DS” subfield indicates whether a data frame originates from the DS.

The “More Fragments” subfield is set to 1 in all data or management frames that have another fragment to follow the MAC service data unit (MSDU) or MAC management protocol data unit (MMPDU) carried by the MAC frame. The “More Fragments” subfield is set to 0 in all other frames in which the “More Fragments” subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The “More Data” subfield indicates to a STA in power save (PS) mode that bufferable units (BUs) are buffered for that STA at the AP. The “More Data” subfield is valid in individually addressed data or management frames transmitted by an AP to a STA in PS mode. The “More Data” subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on the frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), with the 2 most significant bits (MSB) set to 1. In other frames sent by STAs, the duration/ID field contains a duration value (in microseconds) which is used by a recipient to update a network allocation vector (NAV). The NAV is a counter that indicates to a STA an amount of time during which the STA must defer from accessing the shared medium.

Up to four address fields may be present in the MAC frame format. The address fields are used to indicate the basic service set identifier (BSSID), source address (SA), destination address (DA), transmitting address (TA), and receiving address (RA). Certain frames may not contain some of the address fields. Certain address field usage may be specified by the relative position of the address field (1-4) within the MAC header, independent of the type of address present in that field. Specifically, the address I field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. The frame body may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

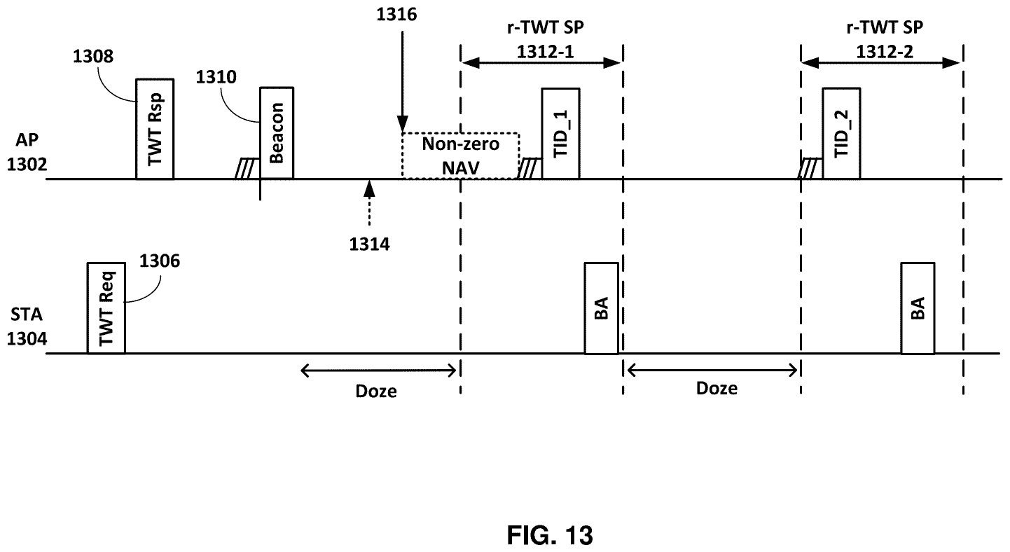

FIG. 13 illustrates an example 1300 of r-TWT operation. As shown in FIG. 13, example 1300 includes an AP 1302 and a STA 1304.

In an example, STA 1304 may transmit a TWT setup request frame 1306 to AP 1302. TWT setup request frame 1306 may include a first broadcast TWT element. The first broadcast TWT element may include a first r-TWT parameter set for a requested r-TWT.

In an example, the requested r-TWT may be a trigger-enabled r-TWT. In an embodiment, a trigger field of the first r-TWT parameter set may be set to 1 to indicate that the requested r-TWT is trigger-enabled.

The first r-TWT parameter set may include first DL/UL bitmaps that indicate respectively first DL/UL TIDs. The first DL/UL TIDs may correspond to DL/UL traffic that may be transmitted during the requested r-TWT. The DL/UL traffic identified by the first DL/UL TIDs may represent latency sensitive traffic.

The first r-TWT parameter set may include a broadcast TWT (b-TWT) identifier identifying a b-TWT membership group associated with the requested r-TWT. The b-TWT identifier may have a value greater than 0.

In response to TWT setup request frame 1306, AP 1302 may respond with a TWT setup response frame 1308. TWT setup response frame 1308 may include a second broadcast TWT element. The second broadcast TWT element may include a second r-TWT parameter set for the requested r-TWT.

The second r-TWT parameter set may include similar parameters as contained in the first r-TWT parameter set. The values of the parameters of the second r-TWT parameter set may be the same or different than the values of the parameters of the first r-TWT SP. In other words, AP 1302 may modify in the second r-TWT parameter set one or more of the parameter values of the first r-TWT parameter set. For example, AP 1302 may modify the DL/UL TIDS that may be transmitted during the r-TWT. The DL/UL TIDs that may be transmitted during the r-TWT are hereinafter referred to as TIDs associated with the r-TWT.

In an embodiment, the second r-TWT parameter set may include the b-TWT identifier identifying the b-TWT membership group associated with the requested r-TWT.

Upon a successful exchange of TWT setup request frame 1306 and TWT setup response frame 1308, the requested r-TWT is setup between AP 1302 and STA 1304. STA 1304 is considered a member r-TWT scheduled STA of the r-TWT. In other words, STA 1304 may be allowed to transmit during service periods of the setup r-TWT. Another STA (not shown in FIG. 13) may join the setup r-TWT by exchanging TWT setup request and response frames with AP 1302. AP 1302 may also add another STA (not shown in FIG. 13) to the setup r-TWT by transmitting a TWT setup response frame to the STA.

Subsequently, AP 1302 may transmit a beacon frame 1310 including a broadcast TWT element. The broadcast TWT element may indicate the b-TWT identifier associated with the setup r-TWT and include a TWT parameter set for the setup r-TWT. The TWT parameter set may include a TWT schedule for the setup r-TWT.

As shown in FIG. 13, the TWT schedule may define a first r-TWT SP 1312-1 and a second r-TWT SP 1312-2. The TWT schedule may be indicated, without limitation, using a target wake time field and a TWT wake interval mantissa field of the broadcast TWT element. The target wake time value may indicate a start time of r-TWT SP 1312-1. The TWT wake interval mantissa value may be used to determine a TWT wake interval. The TWT wake interval represents the amount of time separating successive r-TWT SPs of the setup r-TWT (e.g., the time between the start time of r-TWT SP 1312-1 and a start time of r-TWT SP 1312-2). The start time of r-TWT SP 1312-2 may be determined based on the start time of r-TWT SP 1312-1 and the TWT wake interval.

The TWT parameter set in beacon frame 1310 may also indicate a nominal minimum TWT wake duration. The nominal minimum TWT wake duration may indicate a duration of a service period (e.g., r-TWT SP 1312-1, r-TWT SP 1312-2) of the setup r-TWT.

In an example, STA 1304 may enter a doze state after receiving beacon frame 1310. STA 1304 may wake up at the start time of r-TWT SP 1312-1 to exchange data frames with AP 1302.

In an example, at a time 1314, before the start of r-TWT SP 1312-1, AP 1302 may have buffered data for one or more of the TIDs associated with the setup r-TWT. For example, the buffered data may include data for a first TID (TID_1) and a second TID (TID_2) associated with the setup r-TWT. As STA 1304 may be in a doze state at time 1314, AP 1302 may intend to transmit the buffered data for TID_1 and/or TID_2 during r-TWT SP 1312-1.

In an example, at a time 1316, before the start of r-TWT SP 1312-1, AP 1302 may receive a frame from an Overlapping Basic Service Set (OBSS) (a BSS within communication range of AP 1302 and which transmissions may be heard by AP 1302) (or from a non-EHT (Extremely High Throughput) STA that does not support r-TWT and that does not terminate its transmission at the start of a scheduled r-TWT SP). AP 1302 may set its NAV based on the received OBSS frame. Specifically, AP 1302 may set its NAV based on a duration field included in the received OBSS frame. As mentioned before, AP 1302 may not initiate transmissions on the wireless medium when its NAV is non-zero, regardless of whether a clear channel assessment (CCA) function of the AP senses that the wireless medium is busy.

In an example, as shown in FIG. 13, the OBSS frame received by AP 1302 at time 1316 causes a non-zero NAV at AP 1302 that extends into scheduled r-TWT SP 1312-1. In an example, the non-zero NAV may consume a significant portion of r-TWT SP 1312-1 such that AP 1302 may not be able to transmit the buffered data for both TID_1 and TID_2 during r-TWT SP 1312-1. For example, as shown in FIG. 13, AP 1302 may be able to transmit the buffered data for only TID_1 during r-TWT SP 1312-1. As STA 1304 returns to a doze state at the end of r-TWT SP 1312-1, AP 1302 may have to wait until the start of r-TWT SP 1312-2 to be able to transmit the buffered data for TID_2. As TID_2 may represent latency-sensitive traffic, data for TID_2 may incur unacceptable delay until it may be transmitted by AP 1302. Alternatively, or additionally, buffered data for TID_2 may be discarded at AP 1302 as a TID_2 buffer at AP 1302 may overflow before AP 1302 can transmit data for TID_2.

One solution to the above-described problem may have the STA remain awake after the end of the r-TWT SP until the AP terminates transmission of latency-sensitive data associated with the r-TWT. This solution however may require that the STA signal to the AP that it will remain in the awake state after the end of r-TWT SP so that the AP may schedule additional traffic to the STA. The STA may, for example, switch to the Active Mode to signal to the AP that it will remain in the awake state. This may increase signaling overhead. Additionally, without additional signaling from the AP, the STA may decide to stay in the awake state based only on its uplink buffer status. Thus, the STA may decide to return to the doze state despite that the AP may have buffered downlink data for transmission to the STA.

Embodiments of the present disclosure address the above-described problem by enabling an AP to extend a scheduled r-TWT SP beyond its TWT wake duration. The AP may use the extended r-TWT SP to transmit buffered data for TIDs associated with the r-TWT that cannot be transmitted during the initial r-TWT SP (i.e., before expiration of the wake duration of the r-TWT SP). Embodiments, as further described below, provide a signaling mechanism to allow signaling by a TWT scheduling AP of r-TWT SP extension and r-TWT SP termination to a TWT scheduled STA. The proposed r-TWT SP extension/termination signaling relies on existing signaling as defined in the IEEE 802.11 standard draft “IEEE P802.11-REVme™/D1.2, April 2022.” Embodiments further define a power save behavior for a TWT scheduled STA when r-TWT SP extension is enabled for a scheduled r-TWT SP. According to the defined power save behavior, a TWT scheduled STA may remain in the awake state after expiration of the wake duration of a scheduled r-TWT SP based on r-TWT SP extension signaling from the AP. The TWT scheduled STA may transition to the doze state based on signaling from the AP terminating the extended r-TWT SP.

Extension of the r-TWT SP according to embodiments, as opposed to simply having the STA remain in the awake state after the end of r-TWT SP without extending the r-TWT SP, ensures that traffic prioritization takes place outside the r-TWT SP. For example, in the example of FIG. 13, extension of the r-TWT SP ensures that data for TID_2 can be transmitted right after the wake duration of the scheduled r-TWT SP expires. In contrast, without r-TWT SP extension, other non-latency sensitive traffic may be transmitted by the AP before the TID_2 traffic.

Additionally, by relying on existing signaling, embodiments support r-TWT extension without increasing signaling overhead over the wireless medium. For example, according to embodiments, the AP has no need to explicitly signal extension of the r-TWT SP. Similarly, the STA does not need to signal to the AP that it is remaining in the awake state after expiration of the r-TWT SP.

Further, embodiments have minimal impact on other r-TWT SPs scheduled by the AP on the wireless medium. By extending the r-TWT SP, as opposed to moving the r-TWT SP in its entirety to compensate for any unused portion at the beginning, the r-TWT SP is less likely to overlap with other r-TWT SPs scheduled by the AP. The AP also has no need to explicitly signal a new r-TWT SP start time.

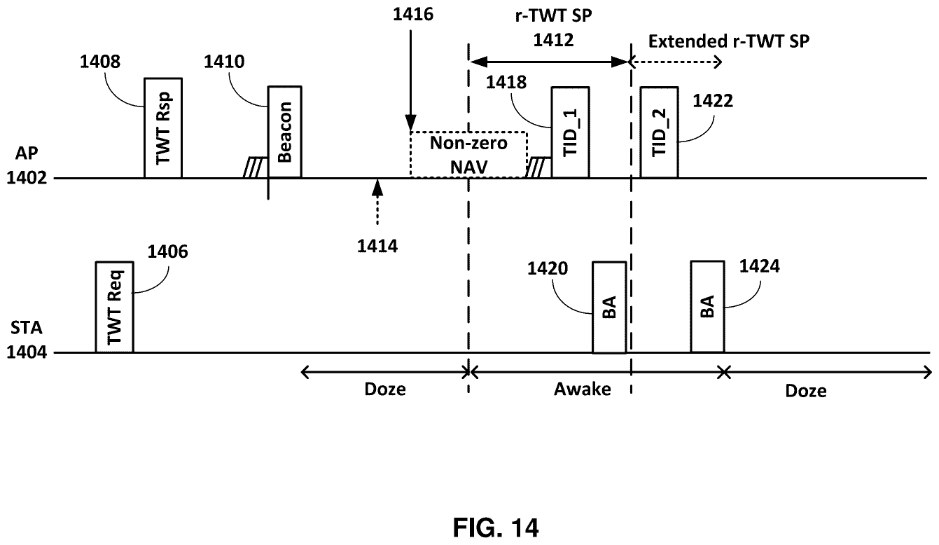

FIG. 14 illustrates an example 1400 of r-TWT operation according to an embodiment. As shown in FIG. 14, example 1400 includes an AP 1402 and a STA 1404.

In an example, STA 1404 may transmit a TWT setup request frame 1406 to AP 1402. TWT setup request frame 1406 may include a first broadcast TWT element. The first broadcast TWT element may include a first r-TWT parameter set for a requested r-TWT.

In an example, the requested r-TWT may be a trigger-enabled r-TWT. In an embodiment, a trigger field of the first r-TWT parameter set may be set to 1 to indicate that the requested r-TWT is trigger-enabled.

The first r-TWT parameter set may include first DI/UL bitmaps that indicate respectively first DL/UL TIDs. The first DL/UL TIDs may correspond to DL/UL traffic that may be transmitted during the requested r-TWT. The DL/UL traffic identified by the first DL/UL TIDs may represent latency sensitive traffic.

The first r-TWT parameter set may include a broadcast TWT (b-TWT) identifier identifying a b-TWT membership group associated with the requested r-TWT. The b-TWT identifier may have a value greater than 0.

In an embodiment, STA 1404 may transmit to AP 1402 an association request frame (not shown in FIG. 14) including an indication regarding support of r-TWT SP extension by STA 1404.

In an embodiment, STA 1404 may support r-TWT SP extension. TWT setup request frame 1406 may include an indication regarding r-TWT SP extension. The indication regarding r-TWT SP extension includes the STA's preference regarding the use or not of r-TWT extension for the r-TWT setup for STA 1404. In an embodiment, the indication regarding r-TWT SP extension may be comprised in a Restricted TWT Traffic Info field of a Broadcast TWT Parameter Set field comprised in r-TWT setup request frame 1406. In an embodiment, the indication regarding r-TWT SP extension may be comprised in a Traffic Info Control field of the Restricted TWT Traffic Info field.

In response to TWT setup request frame 1406, AP 1402 may respond with a TWT setup response frame 1408. TWT setup response frame 1408 may include a second broadcast TWT element. The second broadcast TWT element may include a second r-TWT parameter set for the requested r-TWT.

The second r-TWT parameter set may include similar parameters as contained in the first r-TWT parameter set. The values of the parameters of the second r-TWT parameter set may be the same or different than the values of the parameters of the first r-TWT SP. In other words, AP 1402 may modify in the second r-TWT parameter set one or more of the parameter values of the first r-TWT parameter set. For example, AP 1402 may modify the DL/UL TIDS that may be transmitted during the r-TWT. The DL/UL TIDs that may be transmitted during the r-TWT are hereinafter referred to as TIDs associated with the r-TWT.

In an embodiment, the second r-TWT parameter set may include the b-TWT identifier identifying the b-TWT membership group associated with the requested r-TWT.

In an embodiment, AP 1402 may transmit to STA 1404 an association response frame (not shown in FIG. 14) including an indication regarding support of r-TWT SP extension by AP 1402.

In an embodiment, AP 1402 may support r-TWT SP extension. TWT setup response frame 1408 may include an indication regarding r-TWT SP extension. The indication regarding r-TWT SP extension includes the AP's decision regarding the use or not of r-TWT extension for the requested r-TWT. In an embodiment, the indication regarding r-TWT SP extension may be comprised in a Restricted TWT Traffic Info field of a Broadcast TWT Parameter Set field comprised in r-TWT setup response frame 1408. In an embodiment, the indication regarding r-TWT SP extension may be comprised in a Traffic Info Control field of the Restricted TWT Traffic Info field.

Upon a successful exchange of TWT setup request frame 1406 and TWT setup response frame 1408, the requested r-TWT is setup between AP 1402 and STA 1404. STA 1404 is considered a member r-TWT scheduled STA of the r-TWT. In other words, STA 1404 may be allowed to transmit during service periods of the setup r-TWT. Another STA (not shown in FIG. 14) may join the setup r-TWT by exchanging TWT setup request and response frames with AP 1402. AP 1402 may also add another STA (not shown in FIG. 14) to the setup r-TWT by transmitting a TWT setup response frame to the STA.

Subsequently, AP 1402 may transmit a beacon frame 1410 including a broadcast TWT element. The broadcast TWT element may indicate the b-TWT identifier associated with the setup r-TWT and include a TWT parameter set for the setup r-TWT. The TWT parameter set may include a TWT schedule for the setup r-TWT.

As shown in FIG. 14, the TWT schedule may define an r-TWT SP 1412. The TWT schedule may be indicated, without limitation, using a target wake time field and a TWT wake interval mantissa field of the broadcast TWT element. The target wake time value may indicate a start time of r-TWT SP 1412. The TWT wake interval mantissa value may be used to determine a TWT wake interval. The TWT wake interval represents the amount of time separating successive r-TWT SPs of the setup r-TWT (e.g., the time between the start time of r-TWT SP 1412 and a start time of a subsequent r-TWT SP). The start time of the subsequent r-TWT SP may be determined based on the start time of r-TWT SP 1412 and the TWT wake interval.

The TWT parameter set in beacon frame 1410 may also indicate a nominal minimum TWT wake duration. The nominal minimum TWT wake duration may indicate a duration of a service period (e.g., r-TWT SP 1412) of the setup r-TWT.

In an example, STA 1404 may enter a doze state after receiving beacon frame 1410. STA 1404 may wake up at the start time of r-TWT SP 1412 to exchange data frames with AP 1402.

In an example, at a time 1414, before the start of r-TWT SP 1412, AP 1402 may have buffered data for one or more of the TIDs associated with the setup r-TWT. For example, the buffered data may include data for a first TID (TID_1) and a second TID (TID_2) associated with the setup r-TWT. As STA 1404 may be in a doze state at time 1414, AP 1402 may intend to transmit the buffered data for TID_1 and/or TID_2 during r-TWT SP 1412.

In an example, at a time 1416, before the start of r-TWT SP 1412, AP 1402 may receive a frame from an OBSS (or a legacy STA that does not support r-TWT). AP 1402 may set its NAV based on the received OBSS frame. Specifically, AP 1402 may set its NAV based on a duration field included in the received OBSS frame. In an example, as shown in FIG. 14, the OBSS frame received by AP 1402 at time 1416 causes a non-zero NAV at AP 1402 that extends into scheduled r-TWT SP 1412. In an example, the non-zero NAV may consume a significant portion of r-TWT SP 1412 such that AP 1402 may not be able to transmit the buffered data for both TID_1 and TID_2 during r-TWT SP 1412. For example, as shown in FIG. 14, AP 1402 may be able to transmit the buffered data for only TID_1 during r-TWT SP 1412.

In an embodiment, AP 1402 may transmit a frame 1418 including buffered data for TID_1 during r-TWT SP 1412. AP 1402 may transmit frame 1418 as soon its NAV reaches zero. Frame 1418 may include an MSDU or A-MSDU. AP 1402 may set a value of an end of service period (EOSP) field of frame 1418 based on presence of buffered bufferable units (BUs) for the one or more TIDs associated with the setup r-TWT. In an embodiment, AP 1402 may set the value of the EOSP field of frame 1418 to 0 when buffered BUs are present for the one or more TIDs associated with the r-TWT, and to 1 when buffered BUs are not present for the one or more TIDs associated with the r-TWT. The buffered BUs may include downlink BUs and/or uplink BUs.

In example 1400, AP 1402 may set the EOSP field of frame 1418 to 0 to indicate presence of buffered BUs for TID_2 at AP 1402. A “More Data” field of frame 1418 may also be set to indicate whether buffered BUs are present at AP 1402, regardless of whether the buffered BUs belong to one of the TIDs associated with the r-TWT. In example 1400, as buffered BUs are present for TID_2, the “More Data” field of frame 1418 may be set to 1.

STA 1404 may acknowledge frame 1418 by transmitting a BA frame 1420 to AP 1402. In an embodiment, STA 1404 may remain in the awake state based on receiving, from AP 1402, frame 1418 that includes buffered data for a TID associated with the r-TWT (TID_1) and having an EOSP field set to 0. In an embodiment, STA 1404 may remain in the awake state, beyond expiration of the wake duration of r-TWT SP 1412, based on receiving frame 1418, on the condition of not receiving, at or before expiration of the wake duration of r-TWT SP 1412, a frame comprising a TID associated with the r-TWT and having an EOSP field set to 1.

When AP 1402 receives BA frame 1420 from STA 1404, AP 1402 considers r-TWT SP 1412 to be extended. In other words, AP 1402 may continue to apply, after the end of r-TWT SP 1412 and as long as r-TWT SP 1412 is considered extended, the same AP operating rules applicable during r-TWT SP 1412. The AP operating rules may include traffic prioritization rules according to which latency-sensitive traffic associated with the r-TWT is prioritized over other traffic. The operating rules may also include traffic scheduling rules, including trigger-based traffic scheduling rules when the r-TWT is a trigger-enabled r-TWT. Additionally, AP 1402 operates under the assumption that STA 1404 remains awake as long as r-TWT SP 1412 is considered extended.

At expiration of r-TWT SP 1412, STA 1404 may consider r-TWT SP 1412 to be extended when, after receiving a frame such as frame 1418 during r-TWT SP 1412, no frame comprising a TID associated with the r-TWT and having an EOSP field set to 1 is subsequently received from AP 1402 during r-TWT SP 1412 and before expiration of r-TWT SP 1412. STA 1404 may continue to apply, after the end of r-TWT SP 1412 and as long as r-TWT SP 1412 is considered extended, the same STA operating rules applicable during r-TWT SP 1412.

In example 1400, AP 1402 may transmit a frame 1422 comprising buffered data for one or more TIDs associated with the r-TWT after expiration of r-TWT SP 1412. Frame 1422 may include for example buffered data for TID_2. Frame 1422 may include an MSDU or A-MSDU. An EOSP field of frame 1422 may be set to 0 if further buffered BUs for a TID associated with the r-TWT are available at AP 1402. An EOSP field of frame 1422 may be set to 1 if no more buffered BUs for a TID associated with the r-TWT are available at AP 1402. The buffered BUs may include downlink BUs and/or uplink BUs. A “More Data” field of frame 1422 may be set to indicate whether buffered BUs are present at AP 1402, regardless of whether the buffered BUs belong to one of the TIDs associated with the r-TWT.

STA 1404 may acknowledge frame 1422 by transmitting a BA frame 1424 to AP 1402. In an embodiment, STA 1404 may remain in the awake state after transmitting BA frame 1424 based on frame 1422 having an EOSP field set to 0. In another embodiment, STA 1404 may transition to a doze state after transmitting BA frame 1424 based on frame 1422 having an EOSP field set to 1. In an embodiment, frame 1422 may be comprised in an aggregated MPDU (A-MPDU). The transitioning of STA 1404 to the doze state may be on condition of acknowledging at least one MPDU comprised in the A-MPDU. In another embodiment, the transitioning of STA 1404 to the doze state may be on condition of acknowledging all MPDUs comprised in the A-MPDU. That is, STA 1404 transitions to the doze state, based on receiving frame 1422, only when all MPDUs comprised in the A-MPDU have been received successfully and that none of the MPDUs may require retransmission from AP 1402.

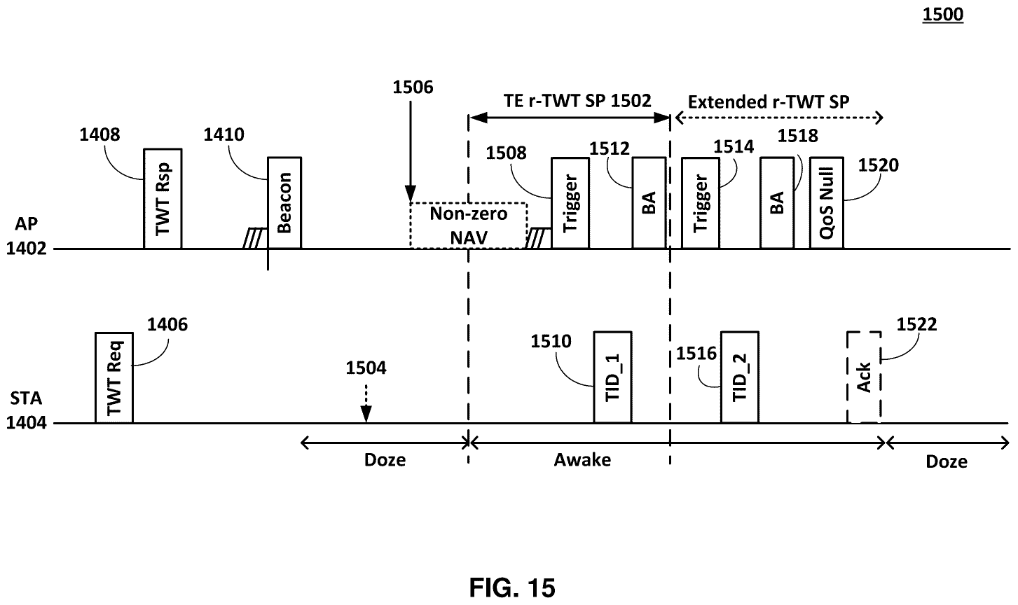

FIG. 15 illustrates an example 1500 of r-TWT operation according to an embodiment. As shown in FIG. 15, example 1500 also includes AP 1402 and STA 1404 described above.

As in example 1400 described above, STA 1404 may transmit a TWT setup request frame 1406 to AP 1402 to request setup of a r-TWT for STA 1404. In example 1500, the requested r-TWT is a trigger-enabled r-TWT. In response to TWT setup request frame 1406, AP 1402 may respond with a TWT setup response frame 1408.

In an embodiment, AP 1402 and STA 1404 may exchange, e.g., in association request/response frames, indications regarding support of r-TWT SP extension by AP 1402 and STA 1404. In an embodiment, STA 1404 may support r-TWT SP extension. TWT setup request frame 1406 may include an indication regarding r-TWT SP extension. The indication regarding r-TWT SP extension includes the STA's preference regarding the use or not of r-TWT extension for the requested r-TWT. In an embodiment, the indication regarding r-TWT SP extension may be comprised in a Restricted TWT Traffic Info field of a Broadcast TWT Parameter Set field comprised in r-TWT setup request frame 1406. In an embodiment, the indication regarding r-TWT SP extension may be comprised in a Traffic Info Control field of the Restricted TWT Traffic Info field. In an embodiment, AP 1402 may support r-TWT SP extension. TWT setup response frame 1408 may include an indication regarding r-TWT SP extension. The indication regarding r-TWT SP extension includes the AP's decision regarding the use or not of r-TWT extension for the requested r-TWT. In an embodiment, the indication regarding r-TWT SP extension may be comprised in a Restricted TWT Traffic Info field of a Broadcast TWT Parameter Set field comprised in r-TWT setup response frame 1408. In an embodiment, the indication regarding r-TWT SP extension may be comprised in a Traffic Info Control field of the Restricted TWT Traffic Info field.

Upon a successful exchange of TWT setup request frame 1406 and TWT setup response frame 1408, the requested r-TWT is setup between AP 1402 and STA 1404.

Subsequently, AP 1402 may transmit a beacon frame 1410 including a broadcast TWT element. The broadcast TWT element may indicate the b-TWT identifier associated with the setup r-TWT and include a TWT parameter set for the setup r-TWT. The TWT parameter set may include a TWT schedule for the setup r-TWT. As shown in FIG. 15, the TWT schedule may define an r-TWT SP 1502. In example 1500, r-TWT SP 1502 is a trigger-enabled r-TWT SP. The TWT schedule may be indicated, without limitation, using a target wake time field and a TWT wake interval mantissa field of the broadcast TWT element. The target wake time value may indicate a start time of r-TWT SP 1502. The TWT wake interval mantissa value may be used to determine a TWT wake interval. The TWT wake interval represents the amount of time separating successive r-TWT SPs of the setup r-TWT (e.g., the time between the start time of r-TWT SP 1502 and a start time of a subsequent r-TWT SP). The start time of the subsequent r-TWT SP may be determined based on the start time of r-TWT SP 1502 and the TWT wake interval. The TWT parameter set in beacon frame 1410 may also indicate a nominal minimum TWT wake duration. The nominal minimum TWT wake duration may indicate a duration of a service period (e.g., r-TWT SP 1502) of the setup r-TWT.

In an example, STA 1404 may enter a doze state after receiving beacon frame 1410. STA 1404 may wake up at the start time of r-TWT SP 1502 to exchange data frames with AP 1402.

In an example, at a time 1504, before the start of r-TWT SP 1502, STA 1404 may have buffered data for one or more of the TIDs associated with the setup r-TWT. For example, the buffered data may include data for a first TID (TID_1) and a second TID (TID_2) associated with the setup r-TWT. As STA 1404 may be in a doze state at time 1414, STA 1404 may intend to transmit the buffered data for TID_1 and/or TID_2 during r-TWT SP 1502.

In an example, at a time 1506, before the start of r-TWT SP 1502, AP 1402 may receive a frame from an OBSS (or a legacy STA that does not support r-TWT). AP 1402 may set its NAV based on the received OBSS frame. Specifically, AP 1402 may set its NAV based on a duration field included in the received OBSS frame. In an example, as shown in FIG. 15, the OBSS frame received by AP 1402 at time 1506 causes a non-zero NAV at AP 1402 that extends into scheduled r-TWT SP 1502. In an example, the non-zero NAV may consume a significant portion of r-TWT SP 1502 such that AP 1402 may be delayed to transmit a trigger frame 1508 that triggers STA 1404 to transmit its buffered data for TID_1 and TID_2. For example, as shown in FIG. 15, AP 1402 may be delayed to transmit trigger frame 1508 to such extent that STA 1404 can only transmit the buffered data for TID_1 during r-TWT SP 1502, but not that for TID_2.

In an embodiment, in response to trigger frame 1508 comprising an identifier (e.g., Association Identifier) of STA 1404, STA 1404 may transmit a frame 1510 comprising buffered data for TID_1 during r-TWT SP 1502. Frame 1510 may include an MSDU or A-MSDU. Frame 1510 may also include a buffer status report (BSR) for TID_1 and/or TID_2. AP 1402 may acknowledge frame 1510 by transmitting a BA frame 1512.

In an embodiment, at expiration of r-TWT SP 1502, AP 1402 may be configured to extend r-TWT SP 1502 beyond expiration of a wake duration of r-TWT SP 1502 on a condition that a last received BSR for a TID associated with the r-TWT indicates a non-empty buffer for the TID at STA 1404. In an example, in frame 1510, the BSR for TID_0 may indicate an empty buffer, and the BSR for TID_1 may indicate a non-empty buffer. As such, after transmitting BA frame 1512, AP 1402 may consider r-TWT SP 1502 to be extended. In other words, AP 1402 may continue to apply, after the end of r-TWT SP 1502 and as long as r-TWT SP 1502 is considered extended, the same AP operating rules applicable during r-TWT SP 1502. The AP operating rules may include traffic prioritization rules according to which latency-sensitive traffic associated with the r-TWT is prioritized over other traffic. The operating rules may also include traffic scheduling rules, including trigger-based traffic scheduling rules when the r-TWT is a trigger-enabled r-TWT. Additionally, AP 1402 operates under the assumption that STA 1404 remains awake as long as r-TWT SP 1502 is considered extended.

In an embodiment, STA 1404 may consider r-TWT SP 1502 extended and may remain in the awake state, beyond expiration of the wake duration of r-TWT SP 1502, based on receiving trigger frame 1508, on the condition of not receiving, at or before expiration of the wake duration of r-TWT SP 1502, a frame comprising a TID associated with the r-TWT and having an EOSP field set to 1.

In example 1500, STA 1404 may receive BA frame 1512 from AP 1402. As no frame comprising a TID associated with the r-TWT and having an EOSP field set to 1 is received by STA 1404 before expiration of r-TWT SP 1502, STA 1404 may consider r-TWT SP 1502 extended and may remain in the awake state after expiration of r-TWT SP 1502. STA 1404 may continue to apply, after the end of r-TWT SP 1502 and as long as r-TWT SP 1502 is considered extended, the same STA operating rules applicable during r-TWT SP 1502.

In example 1500, AP 1402 may transmit a trigger frame 1514 comprising an identifier of STA 1404 after expiration of the wake duration of r-TWT SP 1502. In response to trigger frame 1514, STA 1404 may transmit a frame 1516 comprising buffered data for TID_2. Frame 1516 may include an MSDU or A-MSDU. Frame 1516 may also include a BSR for TID_1 and/or TID_2. AP 1402 may acknowledge frame 1516 by transmitting a BA frame 1518.

In an example, in frame 1516, the BSR may indicate an empty buffer for both TID_1, and TID_2, indicating that STA 1404 has no more buffered BUs for TID_1 and TID_2 associated with the r-TWT. In an embodiment, after acknowledging frame 1516, AP 1402 may transmit a frame 1520 comprising a TID associated with the r-TWT and having an EOSP field set to 1. Frame 1520 may include an MSDU, A-MSDU, or a QoS Null frame. In example 1500, AP 1402 may have no buffered downlink BUs for TID_1 and TID_2 at the time of receiving frame 1516 from STA 1404. As such, frame 1520 may be a QoS Null frame (i.e., without a data payload) having an EOSP field set to 1. In another example, frame 1520 may include an MPDU or an A-MPDU when AP 1402 has buffered BUs for TID_1 and/or TID_2. AP 1402 may consider extended r-TWT SP 1502 terminated after transmitting frame 1520 or after receiving an acknowledgment of frame 1520 from STA 1404.

STA 1404 may acknowledge frame 1520 by transmitting an ACK frame 1522 to AP 1402. In an embodiment, STA 1404 may transition to a doze state after transmitting ACK frame 1522 based on frame 1520 having an EOSP field set to 1. In an embodiment, frame 1520 may be comprised in an A-MPDU. The transitioning of STA 1404 to the doze state may be on condition of acknowledging at least one MPDU comprised in the A-MPDU. In another embodiment, the transitioning of STA 1404 to the doze state may be on condition of acknowledging all MPDUs comprised in the A-MPDU. That is, STA 1404 transitions to the doze state, based on receiving frame 1520, only when all MPDUs comprised in the A-MPDU have been received successfully and that none of the MPDUs may require retransmission from AP 1402. STA 1404 considers the extended r-TWT SP 1502 terminated after transmitting ACK frame 1522 to AP 1402.

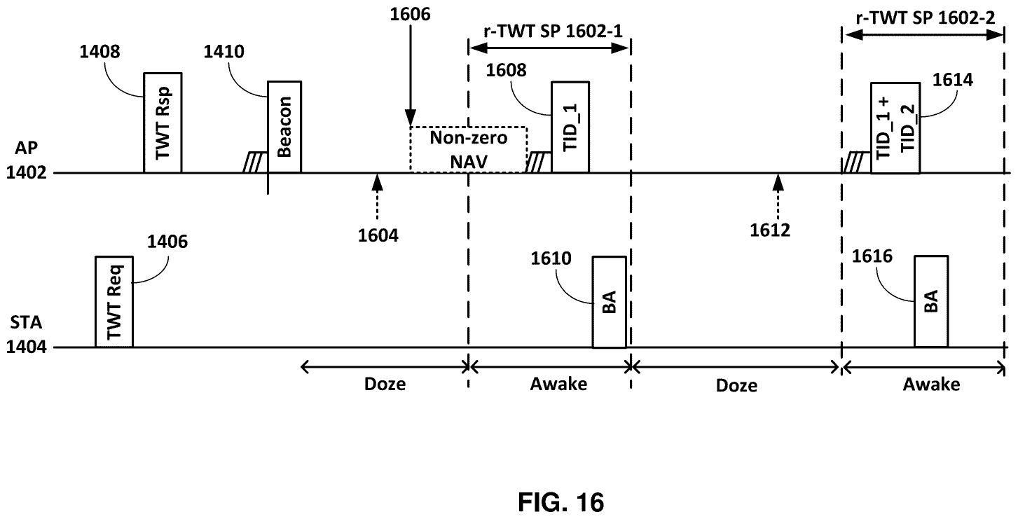

FIG. 16 illustrates an example 1600 of r-TWT operation according to an embodiment. As shown in FIG. 16, example 1600 also includes AP 1402 and STA 1404 described above.

As in example 1400 described above, STA 1404 may transmit a TWT setup request frame 1406 to AP 1402 to request setup of a r-TWT for STA 1404. In response to TWT setup request frame 1406, AP 1402 may respond with a TWT setup response frame 1408.

In an embodiment, AP 1402 and STA 1404 may exchange, e.g., in association request/response frames, indications regarding support of r-TWT SP extension by AP 1402 and STA 1404. In an embodiment, STA 1404 may support r-TWT SP extension. TWT setup request frame 1406 may include an indication regarding r-TWT SP extension. The indication regarding r-TWT SP extension includes the STA's preference regarding the use or not of r-TWT extension for the requested r-TWT. In an embodiment, the indication regarding r-TWT SP extension may be comprised in a Restricted TWT Traffic Info field of a Broadcast TWT Parameter Set field comprised in r-TWT setup request frame 1406. In an embodiment, the indication regarding r-TWT SP extension may be comprised in a Traffic Info Control field of the Restricted TWT Traffic Info field. In an embodiment, AP 1402 may support r-TWT SP extension. TWT setup response frame 1408 may include an indication regarding r-TWT SP extension. The indication regarding r-TWT SP extension includes the AP's decision regarding the use or not of r-TWT extension for the requested r-TWT. In an embodiment, the indication regarding r-TWT SP extension may be comprised in a Restricted TWT Traffic Info field of a Broadcast TWT Parameter Set field comprised in r-TWT setup response frame 1408. In an embodiment, the indication regarding r-TWT SP extension may be comprised in a Traffic Info Control field of the Restricted TWT Traffic Info field.

Upon a successful exchange of TWT setup request frame 1406 and TWT setup response frame 1408, the requested r-TWT is setup between AP 1402 and STA 1404.

Subsequently, AP 1402 may transmit a beacon frame 1410 including a broadcast TWT element. The broadcast TWT element may indicate the b-TWT identifier associated with the setup r-TWT and include a TWT parameter set for the setup r-TWT. The TWT parameter set may include a TWT schedule for the setup r-TWT. As shown in FIG. 16, the TWT schedule may define an r-TWT SP 1602-1 and an r-TWT SP 1602-2. The TWT schedule may be indicated, without limitation, using a target wake time field and a TWT wake interval mantissa field of the broadcast TWT element. The target wake time value may indicate a start time of r-TWT SP 1602-1. The TWT wake interval mantissa value may be used to determine a TWT wake interval. The TWT wake interval represents the amount of time separating successive r-TWT SPs of the setup r-TWT (e.g., the time between the start time of r-TWT SP 1602-1 and a start time of r-TWT SP 1602-2). The start time of r-TWT SP 1602-2 may be determined based on the start time of r-TWT SP 1602-1 and the TWT wake interval. The TWT parameter set in beacon frame 1410 may also indicate a nominal minimum TWT wake duration. The nominal minimum TWT wake duration may indicate a duration of a service period (e.g., r-TWT SP 1602-1 or 1602-2) of the setup r-TWT.

In an example, STA 1404 may enter a doze state after receiving beacon frame 1410. STA 1404 may wake up at the start time of r-TWT SP 1602-1 to exchange data frames with AP 1402.

In an example, at a time 1604, before the start of r-TWT SP 1602-1, AP 1402 may have buffered data for a TID associated with the setup r-TWT (i.e., latency-sensitive data) and buffered data for a TID not associated with the r-TWT (i.e., non-latency-sensitive data). For example, the buffered data may include data for a first TID (TID_1) associated with the r-TWT and data for a second TID (TID_2) not associated with the r-TWT. As STA 1404 may be in a doze state at time 1604, AP 1402 may intend to transmit the buffered data for at least TID_1 during r-TWT SP 1602-1.

In an example, at a time 1606, before the start of r-TWT SP 1602-1, AP 1402 may receive a frame from an OBSS (or a legacy STA that does not support r-TWT). AP 1402 may set its NAV based on the received OBSS frame. Specifically, AP 1402 may set its NAV based on a duration field included in the received OBSS frame. In an example, as shown in FIG. 16, the OBSS frame received by AP 1402 at time 1606 causes a non-zero NAV at AP 1402 that extends into scheduled r-TWT SP 1602-1. In an example, the non-zero NAV may consume a significant portion of r-TWT SP 1602-1 such that AP 1402 may not be able to transmit the buffered data for both TID_1 and TID_2 during r-TWT SP 1602-1. For example, as shown in FIG. 16, AP 1402 may be able to transmit the buffered data for only TID_1 during r-TWT SP 1602-1.

In an embodiment, AP 1402 may transmit a frame 1608 including the buffered data for TID_1 during r-TWT SP 1602-1. Frame 1608 may include some of the buffered data for TID_2 if the remaining time of r-TWT SP 1602-1 allows its transmission. AP 1402 may transmit frame 1608 as soon its NAV reaches zero. Frame 1608 may include an MSDU or A-MSDU. AP 1402 may set a value of an EOSP of frame 1608 based on presence of buffered BUs for the one or more TIDs associated with the setup r-TWT. In an embodiment, AP 1402 may set the value of the EOSP field of frame 1608 to 0 when buffered BUs are present for the one or more TIDs associated with the r-TWT, and to 1 when buffered BUs are not present for the one or more TIDs associated with the r-TWT. The buffered BUs may include downlink BUs and/or uplink BUs.

In example 1600, as TID_2 is not associated with the r-TWT, AP 1402 may set the EOSP field of frame 1608 to 1 to indicate the absence of buffered BUs for TIDs associated with the r-TWT at AP 1402. A “More Data” field of frame 1608 may be set to indicate whether buffered BUs are present at AP 1402, regardless of whether the buffered BUs belong to one of the TIDs associated with the r-TWT. In example 1600, as buffered BUs are present for TID_2, the “More Data” field of frame 1608 may be set to 1.

STA 1404 may acknowledge frame 1608 by transmitting a BA frame 1610 to AP 1402. In an embodiment, STA 1404 may consider r-TWT SP 1602-1 terminated based on transmitting BA frame 1610 in response to frame 1608 that includes buffered data for a TID associated with the r-TWT (TID_1) and having an EOSP field set to 1. In an embodiment, STA 1404 may transition to the doze state based on receiving, from AP 1402, frame 1608 that includes buffered data for a TID associated with the r-TWT (TID_1) and having an EOSP field set to 1. STA 1404 may transition to the doze state at or before expiration of the wake duration of r-TWT SP 1602-1. In an embodiment, STA 1404 may transition to the doze state after transmitting BA frame 1610.

In an example, at a time 1612, before the start of r-TWT SP 1602-2, AP 1402 may again have buffered data for TID_1 (i.e., latency-sensitive data). In addition, AP 1402 may have buffered data for TID_2 that could not be transmitted during r-TWT SP 1602-1. In an example, AP 1402 may transmit, during r-TWT SP 1602-2, a frame 1614 comprising buffered data for TID_1 and buffered data for TID_2. The buffered data for TID_1 is prioritized over the buffered data for TID_2 in frame 1614. In other words, if frame 1614 may not carry all of the buffered data for both TID_1 and TID_2, some of the buffered data for TID_2 may be transmitted in a subsequent frame. In an example, when all the buffered data for TID_1 is transmitted in frame 1614, AP 1402 may set an EOSP field in frame 1614 to 1. A “More Data” field of frame 1614 may be set to 0 or 1 depending on whether buffered BUs are present for TID_2.

STA 1404 may acknowledge frame 1614 by transmitting a BA frame 1616 to AP 1402. In an embodiment, STA 1404 may consider r-TWT SP 1602-2 terminated based on transmitting BA frame 1616 in response to frame 1614 that includes buffered data for a TID associated with the r-TWT (TID_1) and having an EOSP field set to 1. In an embodiment, STA 1404 may transition to the doze state based on receiving, from AP 1402, frame 1608 that includes buffered data for a TID associated with the r-TWT (TID_1) and having an EOSP field set to 1. STA 1404 may transition to the doze state at or before expiration of the wake duration of r-TWT SP 1602-2. In an embodiment, STA 1404 may transition to the doze state after transmitting BA frame 1616.

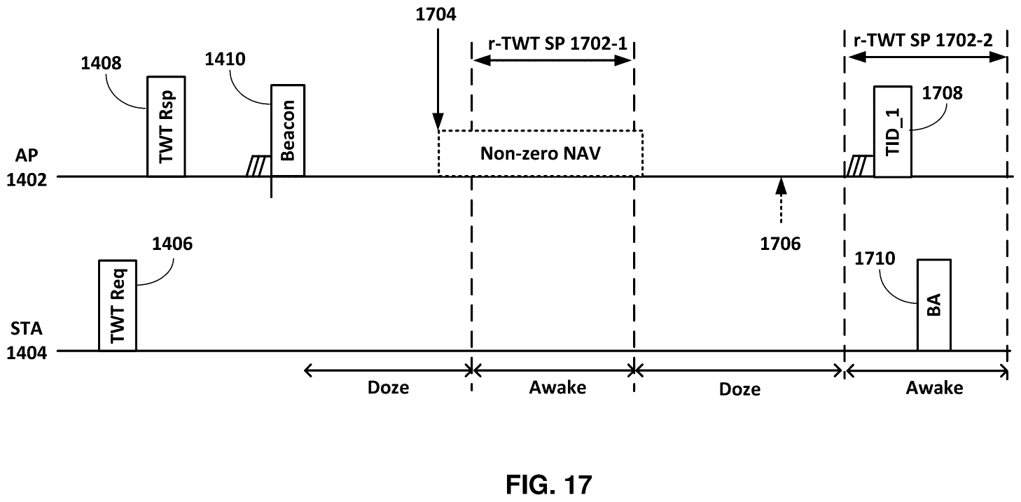

FIG. 17 illustrates an example 1700 of r-TWT operation according to an embodiment. As shown in FIG. 17, example 1700 also includes AP 1402 and STA 1404 described above.

As in example 1400 described above, STA 1404 may transmit a TWT setup request frame 1406 to AP 1402 to request setup of a r-TWT for STA 1404. In response to TWT setup request frame 1406, AP 1402 may respond with a TWT setup response frame 1408.

In an embodiment, AP 1402 and STA 1404 may exchange, e.g., in association request/response frames, indications regarding support of r-TWT SP extension by AP 1402 and STA 1404. In an embodiment, STA 1404 may support r-TWT SP extension. TWT setup request frame 1406 may include an indication regarding r-TWT SP extension. The indication regarding r-TWT SP extension includes the STA's preference regarding the use or not of r-TWT extension for the requested r-TWT. In an embodiment, the indication regarding r-TWT SP extension may be comprised in a Restricted TWT Traffic Info field of a Broadcast TWT Parameter Set field comprised in r-TWT setup request frame 1406. In an embodiment, the indication regarding r-TWT SP extension may be comprised in a Traffic Info Control field of the Restricted TWT Traffic Info field. In an embodiment, AP 1402 may support r-TWT SP extension. TWT setup response frame 1408 may include an indication regarding r-TWT SP extension. The indication regarding r-TWT SP extension includes the AP's decision regarding the use or not of r-TWT extension for the requested r-TWT. In an embodiment, the indication regarding r-TWT SP extension may be comprised in a Restricted TWT Traffic Info field of a Broadcast TWT Parameter Set field comprised in r-TWT setup response frame 1408. In an embodiment, the indication regarding r-TWT SP extension may be comprised in a Traffic Info Control field of the Restricted TWT Traffic Info field.

Upon a successful exchange of TWT setup request frame 1406 and TWT setup response frame 1408, the requested r-TWT is setup between AP 1402 and STA 1404.

Subsequently, AP 1402 may transmit a beacon frame 1410 including a broadcast TWT element. The broadcast TWT element may indicate the b-TWT identifier associated with the setup r-TWT and include a TWT parameter set for the setup r-TWT. The TWT parameter set may include a TWT schedule for the setup r-TWT. As shown in FIG. 17, the TWT schedule may define an r-TWT SP 1702-1 and an r-TWT SP 1702-2. The TWT schedule may be indicated, without limitation, using a target wake time field and a TWT wake interval mantissa field of the broadcast TWT element. The target wake time value may indicate a start time of r-TWT SP 1702-1. The TWT wake interval mantissa value may be used to determine a TWT wake interval. The TWT wake interval represents the amount of time separating successive r-TWT SPs of the setup r-TWT (e.g., the time between the start time of r-TWT SP 1702-1 and a start time of r-TWT SP 1702-2). The start time of r-TWT SP 1702-2 may be determined based on the start time of r-TWT SP 1702-1 and the TWT wake interval. The TWT parameter set in beacon frame 1410 may also indicate a nominal minimum TWT wake duration. The nominal minimum TWT wake duration may indicate a duration of a service period (e.g., r-TWT SP 1702-1 or 1702-2) of the setup r-TWT.

In an example, STA 1404 may enter a doze state after receiving beacon frame 1410. STA 1404 may wake up at the start time of r-TWT SP 1702-1 to exchange data frames with AP 1402.

In an example, at a time 1704, before the start of r-TWT SP 1702-1, AP 1402 may receive a frame from an OBSS (or a legacy STA that does not support r-TWT). AP 1402 may set its NAV based on the received OBSS frame. Specifically, AP 1402 may set its NAV based on a duration field included in the received OBSS frame. In an example, as shown in FIG. 17, the OBSS frame received by AP 1402 at time 1704 causes a non-zero NAV at AP 1402 that extends into and over the entirety of scheduled r-TWT SP 1702-1. As such, AP 1402 may not be able to transmit any frame comprising a TID associated with the r-TWT (i.e., latency-sensitive data) during r-TWT SP 1702-1. Additionally, when the r-TWT is trigger-enabled, AP 1402 may not be able to transmit any trigger frame during r-TWT SP 1702-1 to trigger STA 1404 to transmit latency-sensitive data during r-TWT SP 1702-1.

In an embodiment, STA 1404 may be configured to transition to the doze state, at expiration of the wake duration of r-TWT SP 1702-1, on condition of not receiving from AP 1402, before expiration of the wake duration of r-TWT SP 1702-1: a data frame comprising a TID associated with the r-TWT (i.e., latency-sensitive data); or a trigger frame indicating an identifier of the STA. In example 1700, STA 1404 receives no frames from AP 1402 during r-TWT SP 1702-1. As such, STA 1404 transitions to the doze state at expiration of r-TWT SP 1702-1.

In an example, at a time 1706, before the start of r-TWT SP 1702-2, AP 1402 may have buffered data for a TID associated with the r-TWT (i.e., latency-sensitive data). For example, the buffered data may include data for a first TID (TID_1) associated with the r-TWT. As STA 1404 may be in a doze state at time 1706, AP 1402 may wait for r-TWT SP 1702-2 to transmit the buffered data for TID_1 to STA 1404. In an embodiment, AP 1402 may transmit a frame 1708 comprising the buffered data for TID_1 to STA 1404. Frame 1708 may include an MSDU or an A-MSDU. An ESOP field of frame 1708 may be set to 0 or 1 based on whether further buffered data for TIDs associated with the r-TWT is present at AP 1402.

STA 1404 may acknowledge frame 1708 by transmitting a BA frame 1710 to AP 1402. In an embodiment, STA 1404 may consider r-TWT SP 1702-2 terminated based on receiving, from AP 1402, frame 1708 that includes buffered data for a TID associated with the r-TWT (TID_1) and having an EOSP field set to 1. In an embodiment, STA 1404 may transition to the doze state based on receiving, from AP 1402, frame 1708 that includes buffered data for a TID associated with the r-TWT (TID_1) and having an EOSP field set to 1. STA 1404 may transition to the doze state at or before expiration of the wake duration of r-TWT SP 1702-1. In an embodiment, STA 1404 may transition to the doze state after transmitting BA frame 1710.

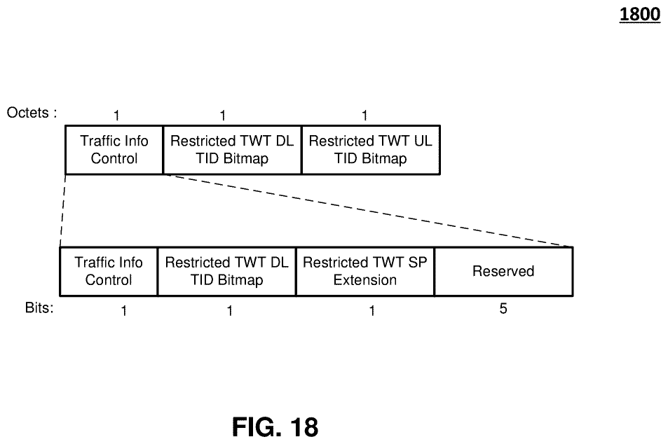

FIG. 18 illustrates an example Restricted TWT Traffic Info field 1800 according to an embodiment. Restricted TWT Traffic Info field 1800 may be present in a Restricted (or Broadcast) TWT Parameter set of a TWT element. Specifically, Restricted TWT Traffic Info field 1800 may be present in a Restricted TWT Parameter set when a Restricted TWT Traffic Info Present subfield of a Broadcast TWT Info subfield of the TWT element is set to 1.

In an embodiment, Restricted TWT Traffic Info field 1800 may be used by a STA or an AP to signal an indication regarding r-TWT SP extension. For a STA, the indication regarding r-TWT SP extension may include the STA's preference regarding the use or not of r-TWT extension for an r-TWT being requested by the STA. The STA may include the TWT element comprising Restricted TWT Traffic Info field 1800 in an r-TWT setup request frame. For an AP, the indication regarding r-TWT SP extension may include the AP's decision regarding the use or not of r-TWT extension for a r-TWT being setup for a STA. The AP may include the TWT element comprising Restricted TWT Traffic Info field 1800 in an r-TWT setup response frame.

As shown in FIG. 18, Restricted TWT Traffic Info field 1800 may include a Traffic Info Control field, a Restricted TWT DL TID bitmap, and a Restricted TWT UL TID bitmap. In an embodiment, the Traffic Info Control field may include a Traffic Info Control subfield, a Restricted TWT DL TID bitmap subfield, a Restricted TWT SP extension subfield, and Reserved bits. The Restricted TWT SP extension subfield may be used by an AP or STA to signal the indication regarding r-TWT SP extension for the r-TWT being setup.

In an embodiment, a Restricted TWT SP Extension subfield set to 1 in a TWT Response frame that indicates Accept TWT shall indicate that the r-TWT SP may be extended by the r-TWT scheduling AP. A value of 0 in the Restricted TWT SP Extension subfield shall indicate that the r-TWT SP extension is not allowed and the TWT scheduling AP and the TWT scheduled STA shall follow the rules defined in sections 26.8.3.2 (Rules for TWT scheduling AP), 26.8.3.3 (Rules for TWT scheduled STA) and, 26.8.5 (Power save operation during TWT SPs) of the IEEE 802.11 standard draft “IEEE P802.11-REVme™/D1.2, April 2022.”

In an embodiment, if the Restricted TWT SP Extension subfield in the TWT Response frame that indicates Accept TWT is set to 1, the r-TWT scheduling AP and the r-TWT scheduled STA shall follow the rules specified below.

An r-TWT scheduling AP shall indicate the end of the r-TWT SP using the EOSP subfield of the QoS Control field to the r-TWT scheduled STA. If the r-TWT scheduling AP has buffered DL/UL BUs associated with r-TWT TID(s) for the r-TWT scheduled STA within the r-TWT SP, the r-TWT scheduling AP shall transmit a QoS Null frame, MSDU, or A-MSDU with the EOSP subfield set to 0 to the r-TWT scheduled STA. If the r-TWT scheduling AP has no buffered DL/UL BUs associated with r-TWT TID(s) for the r-TWT scheduled STA, the r-TWT scheduling AP shall transmit a QoS Null frame, MSDU, or A-MSDU with the EOSP subfield set to 1 to the r-TWT scheduled STA.

An r-TWT scheduled STA shall be in awake state during the AdjustedMinimumTWTWakeDuration time under the following condition: The r-TWT scheduled STA has not received a QoS Null frame, MSDU, or A-MSDU with the EOSP subfield set to 1 from the r-TWT scheduling AP.

An r-TWT scheduled STA shall be in awake state even when the AdjustedMinimumTWTWakeDuration time expires under the following conditions:
The r-TWT scheduled STA received a QoS Null frame, MSDU, or A-MSDU with the EOSP subfield set to 0 during the r-TWT SP, but the STA has not received a QoS Null frame, MSDU, or A-MSDU with the EOSP subfield set to 1.
The r-TWT scheduled STA received a Trigger frame including an AID of the STA during a trigger-enabled r-TWT SP, but the STA has not received a QoS Null frame, MSDU, or A-MSDU with the EOSP subfield equal to 1.

An r-TWT scheduled STA may enter doze state under one of the following conditions:
The r-TWT scheduled STA transmits an acknowledgment in response to an individually addressed QoS Data or QoS Null frame, sent by an r-TWT scheduling AP and having the EOSP subfield equal to 1.
The r-TWT scheduled STA transmits a BlockAck frame that acknowledges all MPDUs in response to an individually addressed A-MPDU, containing QoS Data frames sent by the r-TWT scheduling AP and having the EOSP subfield equal to 1.
The AdjustedMinimumTWTWakeDuration time expires and the r-TWT scheduled STA has received neither MSDUs/A-MSDU with r-TWT TID(s) nor a Trigger frame including the STA's AID from the r-TWT scheduling AP.

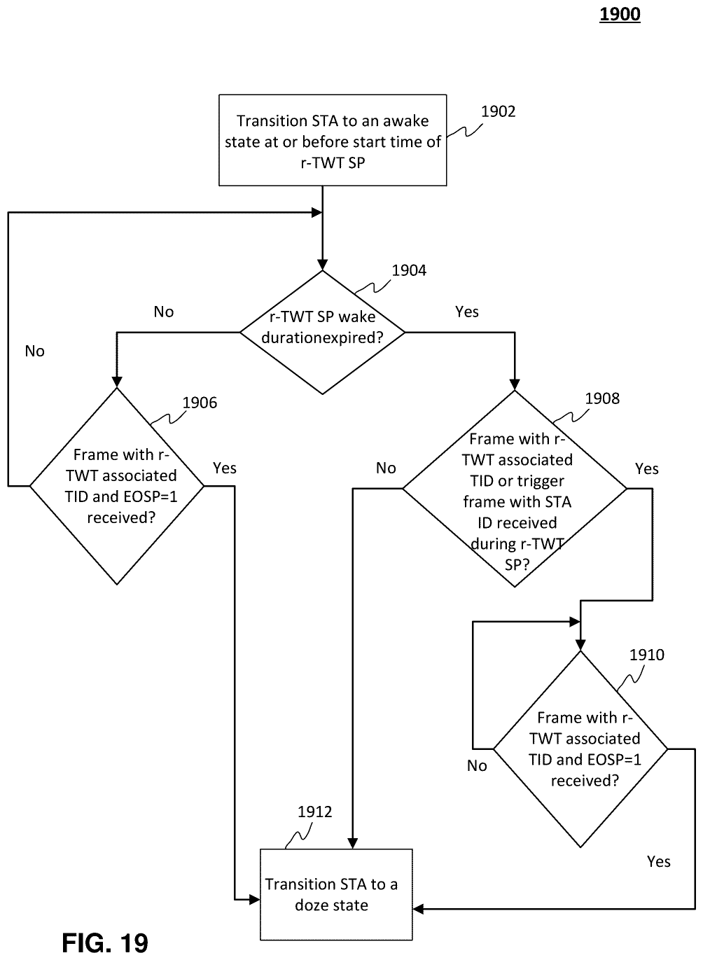

FIG. 19 illustrates an example process 1900 according to an embodiment. Example process 1900 is provided for the purpose of illustration only and is not limiting of embodiments of the present disclosure. Example process 1900 may be performed by a STA (i.e., non-AP STA).

As shown in FIG. 19, example process 1900 begins in step 1902, which includes transitioning a STA to an awake state at or before a start time of a r-TWT SP of a r-TWT. The r-TWT may be set up for the STA by an AP, with which the STA is associated. The r-TWT may be associated with one or more TIDs. The start time of the r-TWT SP may be indicated to the STA by the AP in a frame transmitted by the AP to the STA. The frame may also indicate a wake duration of the r-TWT SP. The wake duration may be an AdjustedMinimumTWTWakeDuration associated with the r-TWT SP. In an embodiment, the frame may be a beacon frame or a TWT setup response frame.

Subsequently, process 1900 may transition to step 1904, which includes determining whether the wake duration of the r-TWT SP has expired. If the answer is no, process 1900 may transition to step 1906. Otherwise, if the answer is yes, process 1900 may transition to step 1908.

In step 1906, process 1900 may include determining whether a frame comprising a TID associated with the r-TWT (i.e., of the one or more TIDs associated with the r-TWT) and having an end of service period (EOSP) field set to 1 has been received by the STA. The frame comprising a TID associated with the r-TWT and having an EOSP field set to 1 may include a QoS data frame. The EOSP field may be included in a QoS control field of the QoS data frame. The frame comprising a TID associated with the r-TWT and having an EOSP field set to 1 may include an MSDU, an A-MSDU, or a QoS Null frame. If the answer is no, process 1900 may return to step 1904. Otherwise, if the answer is yes, process 1900 may transition to step 1912, which includes transitioning the STA to a doze state.

In step 1908, process 1900 may include determining whether a frame comprising a TID associated with the r-TWT (i.e., of the one or more TIDs associated with the r-TWT) and having an EOSP field set to 0 or a trigger frame indicating an identifier of the STA has been received by the STA during the r-TWT SP (i.e., before expiration of the wake duration of the r-TWT SP). The frame comprising a TID associated with the r-TWT and having an EOSP field set to 0 may include a QoS data frame. The EOSP field may be included in a QoS control field of the QoS data frame. The frame comprising a TID associated with the r-TWT and having an EOSP field set to 0 may include an MSDU, an A-MSDU, or a QoS Null frame. If the answer is no, process 1900 may transition to step 1912, which includes transitioning the STA to a doze state. Otherwise, if the answer is yes, process 1900 may transition to step 1910.

In step 1910, process 1900 may include determining whether a frame comprising a TID associated with the r-TWT (i.e., of the one or more TIDs associated with the r-TWT) and having an EOSP field set to I has been received by the STA. The frame comprising a TID associated with the r-TWT and having an EOSP field set to 1 may include a QoS data frame. The EOSP field may be included in a QoS control field of the QoS data frame. The frame comprising a TID associated with the r-TWT and having an EOSP field set to 1 may include an MSDU, an A-MSDU, or a QoS Null frame. If the answer is no, process 1900 may return to step 1910. Otherwise, if the answer is yes, process 1900 may transition to step 1912, which includes transitioning the STA to add doze state.

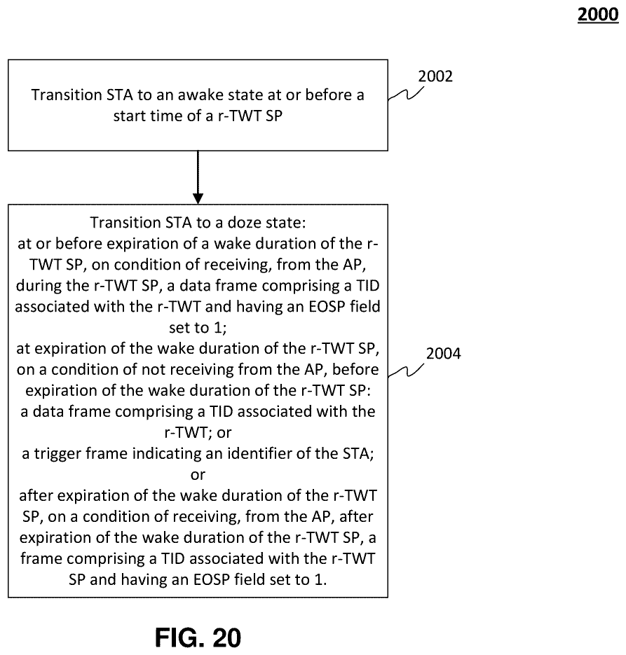

FIG. 20 illustrates an example process 2000 according to an embodiment. Example process 2000 is provided for the purpose of illustration only and is not limiting of embodiments of the present disclosure. Example process 2000 may be performed by a STA (i.e., non-AP STA). As shown in FIG. 2, example process 2000 includes a step 2002 and a step 2004.

In step 2002, process 2000 includes transitioning the STA to an awake state at or before a start time of a r-TWT SP of a r-TWT. The r-TWT may be set up for the STA by an AP, with which the STA is associated. The r-TWT may be associated with one or more TIDs. The start time of the r-TWT SP may be indicated to the STA by the AP in a frame transmitted by the AP to the STA. The frame may also indicate a wake duration of the r-TWT SP. The wake duration may be an AdjustedMinimumTWTWakeDuration associated with the r-TWT SP. In an embodiment, the frame may be a beacon frame or a TWT setup response frame.

In step 2002, process 2000 includes transitioning the STA from the awake state to a doze state when, at a given time instant, one or more of the below-described first, second, and third conditions are met. The first condition is tested at or before expiration of the wake duration of the r-TWT SP (as long as the STA is still in the awake state). The second condition is tested at the moment of expiration of the wake duration of the r-TWT SP (as long as the STA is still in the awake state, i.e., has not transitioned to the doze state due to the first condition). The third condition is tested after expiration of the wake duration of the r-TWT SP (as long as the STA is still in the awake state, i.e., has not transitioned to the doze state due to the first and/or second condition). As would be understood by a person of skill in the art based on the teachings herein, it may be possible (though rare) that both the first and the second conditions are met at the moment of expiration of expiration of the wake duration of the r-TWT SP.

According to the first condition, the STA transitions to the doze state, at or before expiration of the wake duration of the r-TWT SP, on condition of receiving, from the AP, during the r-TWT SP, a frame comprising a TID associated with the r-TWT (i.e., of the one or more TIDs associated with the r-TWT) and having an EOSP field set to 1. In other words, when, during the r-TWT SP or at the moment of expiration of the wake duration of the r-TWT SP, the STA receives a frame comprising a TID associated with the r-TWT and having an EOSP field set to 1, the STA considers that the r-TWT SP is terminated and transitions to the doze state. The frame comprising a TID associated with the r-TWT and having an EOSP field set to 1 may include a QoS data frame. The EOSP field may be included in a QoS control field of the QoS data frame. The frame comprising a TID associated with the r-TWT and having an EOSP field set to 1 may include an MSDU, an A-MSDU, or a QoS Null frame.

According to the second condition, the STA transitions to the doze state, at expiration of the wake duration of the r-TWT SP, on condition of not receiving from the AP, before expiration of the wake duration of the r-TWT SP (i.e., during the r-TWT SP): a data frame comprising a TID associated with the r-TWT; or a trigger frame indicating an identifier of the STA. In other words, if the STA does not transition to the doze state due to the first condition (i.e., due to receiving a frame comprising a TID associated with the r-TWT and having an EOSP field set to 1), and the wake duration of the r-TWT SP expires, the STA transitions to the doze state, at the moment of expiration of the wake duration, if no downlink data frame associated with the r-TWT or trigger frame indicating an identifier of the STA has been received by the STA during the r-TWT SP. This condition translates to the STA not receiving from the AP any frame relating to the r-TWT during the r-TWT SP. The STA thus considers the r-TWT SP terminated and transitions to the doze state. The frame comprising a TID associated with the r-TWT may include a QoS data frame. The EOSP field may be included in a QoS control field of the QoS data frame. The frame comprising a TID associated with the r-TWT may include an MSDU, an A-MSDU, or a QoS Null frame.

According to the third condition, the STA transitions to the doze state, after expiration of the wake duration of the r-TWT SP, on condition of receiving, from the AP, after the expiration of the wake duration of the r-TWT SP, a frame comprising TID associated with the r-TWT and having an EOSP field set to 1. In other words, if the STA does not transition to the doze state due to the first condition, nor due to the second condition, the STA may consider the r-TWT SP extended and may remain in the awake state. The STA may subsequently transition to the doze state, after the expiration of the wake duration of the r-TWT SP, due to the third condition. Transition according to this condition assumes that the STA: 1) does not receive during the r-TWT SP a frame comprising a TID associated with the r-TWT and having an EOSP field set to 1; and 2) receives during the r-TWT SP either a trigger frame indicating an identifier of the STA or a frame comprising a TID associated with the r-TWT and having an EOSP field set to 0. The frame comprising a TID associated with the r-TWT and having an EOSP field set to 1 may include a QoS data frame. The EOSP field may be included in a QoS control field of the QoS data frame. The frame comprising a TID associated with the r-TWT and having an EOSP field set to 1 may include an MSDU, an A-MSDU, or a QoS Null frame.

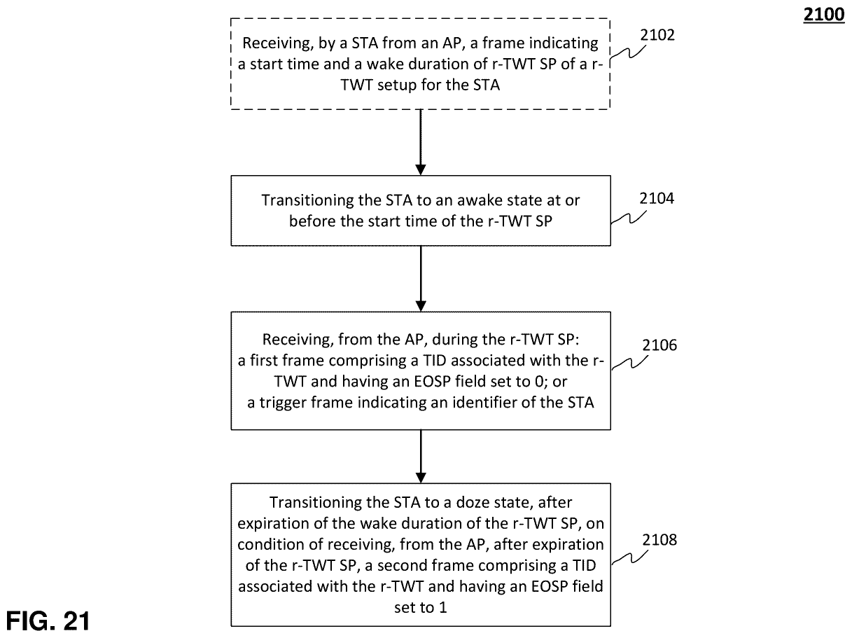

FIG. 21 illustrates an example process 2100 according to an embodiment. Example process 2100 is provided for the purpose of illustration only and is not limiting of embodiments of the present disclosure. Example process 2100 may be performed by a STA (i.e., non-AP STA). As shown in FIG. 21, example process 2100 includes steps 2102, 2104, 2106, and 2108. Step 2102 may be optional.

In step 2102, process 2100 may include receiving, by the STA from an AP, a frame indicating a start time and a wake duration of a r-TWT SP of a r-TWT setup for the STA. The r-TWT may be set up for the STA by an AP, with which the STA is associated. The r-TWT may be associated with one or more TIDs. The wake duration may be an AdjustedMinimumTWTWakeDuration associated with the r-TWT SP. In an embodiment, the frame may be a beacon frame or a TWT setup response frame.

In step 2104, process 2100 may include transitioning the STA to an awake state at or before the start time of the r-TWT SP. The transition to the awake state may be from a doze state.

In step 2106, process 2100 may include receiving, from the AP, during the r-TWT SP: a first frame comprising a TID associated with the r-TWT and having an EOSP field set to 0; or a trigger frame indicating an identifier of the STA. The first frame comprising a TID associated with the r-TWT and having an EOSP field set to 0 may include a QoS data frame. The EOSP field may be included in a QoS control field of the QoS data frame. The first frame comprising a TID associated with the r-TWT and having an EOSP field set to 0 may include an MSDU, an A-MSDU, or a QoS Null frame.

In an embodiment, step 2106 may include receiving, during the r-TWT SP, the trigger frame indicating the identifier of the STA. Process 2100 may further include transmitting, from the STA to the AP, during the r-TWT SP, a third frame comprising a TID from among the one or more TIDs associated with the r-TWT. The third frame may be transmitted in response to the trigger frame.

In step 2108, process 2100 may include transitioning the STA to a doze state, after expiration of a wake duration of the r-TWT SP, on condition of receiving, from the AP, after expiration of the wake duration of the r-TWT SP, a second frame comprising a TID associated with the r-TWT and having an EOSP field set to 1. The second frame comprising a TID associated with the r-TWT and having an EOSP field set to 1 may include a QoS data frame. The EOSP field may be included in a QoS control field of the QoS data frame. The second frame comprising a TID associated with the r-TWT and having an EOSP field set to 1 may include an MSDU, an A-MSDU, or a QoS Null frame.

In an embodiment of process 2100, the STA may remain in the awake state beyond the expiration of the wake duration of the r-TWT SP. The STA may remain in the awake state, beyond the expiration of the wake duration of the r-TWT SP, on condition of not receiving, from the AP, during the r-TWT SP, a frame comprising a TID associated with the r-TWT and having an EOSP field set to 1. After expiration of the wake duration of the r-TWT SP, the STA may receive a further frame from the AP. The further frame may include an MSDU, an A-MSDU, or a QoS Null frame. The further frame may be the second frame comprising a TID associated with the r-TWT and having an EOSP field set to 1. The STA may transition to the doze state based on receiving the second frame. Alternatively, the further frame may be a frame comprising a TID associated with the r-TWT and having an EOSP field set to 0. The STA may remain in the awake state when the EOSP field of the further frame is set to 0.

In an embodiment, process 2100 may further include transitioning the STA to the doze state before the expiration of the wake duration of the r-TWT SP on condition of receiving, from the AP, during the r-TWT SP, a frame comprising a TID associated with the r-TWT and having an EOSP field set to 1.

In an embodiment, process 2100 may include receiving, during the r-TWT SP, a frame comprising a TID associated with the r-TWT and having an EOSP field set to 1. The STA may transition to the doze state, at or before expiration of the wake duration of the r-TWT SP, based on receiving the frame comprising a TID associated with the r-TWT and having an EOSP field set to 1. A more “More Data” field of the received frame may be set to 0 or 1. That is, the STA may transition to the doze state, irrespective of whether more data is available for transmission at the AP. In an embodiment, the AP may set the “More Data” field of the frame to 0 when no downlink/uplink data associated with the r-TWT (i.e., data having a TID from among the one or more TIDs associated with the r-TWT, i.e., latency-sensitive data) is buffered for transmission. In another embodiment, the AP may set the “More Data” field of the frame to 1 when no downlink/uplink latency sensitive data is buffered for transmission and/or when no downlink/uplink data at all (both latency-sensitive and non-latency-sensitive) is buffered for transmission.

In an embodiment, the “More Data” field of the received frame is set to 1. Process 2100 may further include transitioning the STA to the awake state at or before a start time of a subsequent r-TWT SP of the r-TWT setup for the STA; and receiving, during the subsequent r-TWT SP, a frame comprising a TID not associated with the r-TWT. That is, according to this embodiment, the AP may set the “More Data” field of the frame (received during the r-TWT SP and having an EOSP field set to 1) to 1 to indicate that non-latency-sensitive data is available for transmission. The STA transitions to the doze state upon receiving the frame with the EOSP field set to 1, even when the “More Data” field is set to 1. The AP transitions to the awake state at the start time of a subsequent r-TWT SP, during which the non-latency-sensitive data may be transmitted by the AP.

In an embodiment, process 2100 may further include transmitting, from the STA to the AP, an ACK or a Block Ack (BA) frame in response to the first frame or the second frame.

Transmitting an ACK or BA frame in response to the second frame may be performed, regardless of whether the second frame is received during the r-TWT SP or after expiration of the wake duration of the r-TWT SP. In an embodiment, the transitioning of the STA to the doze state, based on receiving the second frame, includes transitioning the STA to the doze state after transmitting the ACK or BA frame. In an embodiment, the second frame is comprised in an A-MPDU, and the transitioning of the STA to the doze state, based on receiving the second frame, includes transitioning the STA to the doze state on condition of acknowledging at least one MPDU comprised in the A-MPDU. In another embodiment, the second frame is comprised in an A-MPDU, and the transitioning of the STA to the doze state, based on receiving the second frame, includes transitioning the STA to the doze state on condition of acknowledging all MPDUs comprised in the A-MPDU. That is, the STA transitions to the doze state, based on receiving the second frame, only when all MPDUs comprised in the A-MPDU have been received successfully and that none of the MPDUs may require retransmission from the AP.

In an embodiment, process 2100 may further include, for example before step 2102, transmitting, from the STA to the AP, an association request frame comprising an indication regarding support of r-TWT SP extension by the STA.

In an embodiment, process 2100 may further include, for example before step 2102, receiving, by the STA from the AP, an association response frame comprising an indication regarding support of r-TWT SP extension by the AP.

In an embodiment, where the STA supports r-TWT extension, process 2100 may further include, for example before step 2102, transmitting, from the STA to the AP, an r-TWT setup request frame comprising an indication regarding r-TWT SP extension. The indication regarding r-TWT SP extension includes the STA's preference regarding the use or not of r-TWT extension for the r-TWT setup for the STA.

In an embodiment, where the AP supports r-TWT extension, process 2100 may further include, for example before step 2102, receiving, by the STA from the AP, an r-TWT setup response frame comprising an indication regarding r-TWT SP extension. The indication regarding r-TWT SP extension includes the AP's decision regarding the use or not of r-TWT extension for the r-TWT setup for the STA. When r-TWT extension is used, the STA may operate in accordance with the above-described embodiments of process 2100, i.e., the STA may transition to the doze state as described herein.

In an embodiment, the indication regarding r-TWT SP extension may be comprised in a Restricted TWT Traffic Info field of a Broadcast TWT Parameter Set field comprised in the r-TWT setup request and/or the r-TWT setup response frame. In an embodiment, the indication regarding r-TWT SP extension may be comprised in a Traffic Info Control field of the Restricted TWT Traffic Info field.

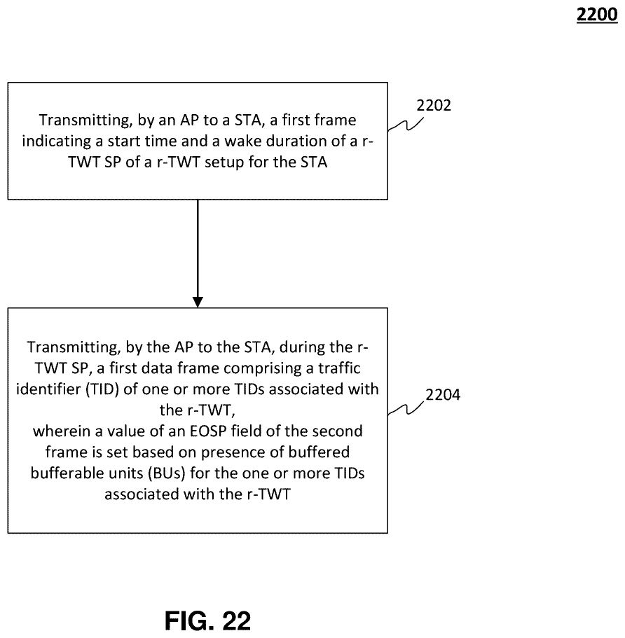

FIG. 22 illustrates an example process 2200 according to an embodiment. Example process 2200 is provided for the purpose of illustration only and is not limiting of embodiments of the present disclosure. Example process 2200 may be performed by an AP. As shown in FIG. 22, process 2200 may include steps 2202 and 2204.

In step 2202, process 2200 may include transmitting, by the AP to a STA, a first frame indicating a start time and a wake duration r-TWT SP of a r-TWT setup for the STA. The r-TWT may be set up for the STA by the AP, with which the STA is associated. The r-TWT may be associated with one or more TIDs. The wake duration may be an AdjustedMinimumTWTWakeDuration associated with the r-TWT SP. In an embodiment, the first frame may be a beacon frame or a TWT setup response frame.

In step 2204, process 2200 may include transmitting, by the AP to the STA, during the r-TWT SP, a second frame comprising a TID of the one or more TIDs associated with the r-TWT. In an embodiment, a value of an EOSP field of the second frame is set based on presence of buffered bufferable units (BUs) for the one or more TIDs associated with the r-TWT. The buffered BUs may include downlink DUs and/or uplink BUs. The second frame may include an MSDU, an A-MSDU, or a QoS Null frame.

In an embodiment, the value of the EOSP field of the second frame is set to 0 when buffered BUs are present for the one or more TIDs associated with the r-TWT. In an embodiment, the value of the EOSP field of the second frame is set to 1 when buffered BUs are not present for the one or more TIDs associated with the r-TWT.

In an embodiment, where the value of the EOSP field of the second frame is set to indicate presence of buffered BUs for the one or more TIDs associated with the r-TWT, process 2200 may further include transmitting, by the AP to the STA, after expiration of the wake duration of the r-TWT SP, a third frame comprising a TID of the one or more TIDs associated with the r-TWT. An EOSP field of the third frame may be set to 0 or 1. The third frame may include an MSDU, an A-MSDU, or a QoS Null frame.

In an embodiment, process 2200 may further include, for example before step 2202, receiving, by the AP from the STA, an association request frame comprising an indication regarding support of r-TWT SP extension by the STA.

In an embodiment, process 2200 may further include, for example before step 2202, transmitting, by the AP to the STA, an association response frame comprising an indication regarding support of r-TWT SP extension by the AP.

In an embodiment, where the STA supports r-TWT extension, process 2200 may further include, for example before step 2202, receiving, by the AP from the STA, an r-TWT setup request frame comprising an indication regarding r-TWT SP extension. The indication regarding r-TWT SP extension includes the STA's preference regarding the use or not of r-TWT extension for the r-TWT setup for the STA.

In an embodiment, where the AP supports r-TWT extension, process 2200 may further include, for example before step 2202, transmitting, by the AP to the STA, an r-TWT setup response frame comprising an indication regarding r-TWT SP extension. The indication regarding r-TWT SP extension includes the AP's decision regarding the use or not of r-TWT extension for the r-TWT setup for the STA. When r-TWT extension is used, the AP may operate in accordance with the above-described embodiments of process 2200.

In an embodiment, the indication regarding r-TWT SP extension may be comprised in a Restricted TWT Traffic Info field of a Broadcast TWT Parameter Set field comprised in the r-TWT setup request and/or the r-TWT setup response frame. In an embodiment, the indication regarding r-TWT SP extension may be comprised in a Traffic Info Control field of the Restricted TWT Traffic Info field.

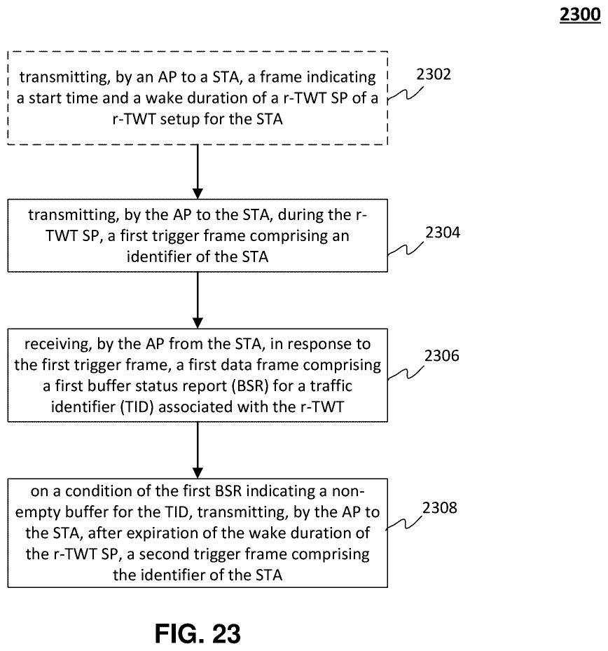

FIG. 23 illustrates an example process 2300 according to an embodiment. Example process 2300 is provided for the purpose of illustration only and is not limiting of embodiments of the present disclosure. Example process 2300 may be performed by an AP. As shown in FIG. 22, process 2200 may include steps 2302, 2304, 2306, and 2308. Step 2302 may be optional.

In step 2302, process 2300 may include transmitting, by the AP to a STA, a frame indicating a start time and a wake duration r-TWT SP of a r-TWT setup for the STA. The r-TWT may be set up for the STA by the AP, with which the STA is associated. The r-TWT may be associated with one or more TIDs. The wake duration may be an AdjustedMinimumTWTWakeDuration associated with the r-TWT SP. In an embodiment, the frame may be a beacon frame or a TWT setup response frame.

In step 2304, process 2300 may include transmitting, by the AP to the STA, during the r-TWT SP, a first trigger frame comprising an identifier of the STA.

In step 2306, process 2300 may include receiving, by the AP from the STA, in response to the first trigger frame, a first data frame comprising a first buffer status report (BSR) for a TID of the one or more TIDs associated with the r-TWT.

In step 2308, process 2300 may include on condition of the first BSR indicating a non-empty buffer for the TID, transmitting, by the AP to the STA, after expiration of the wake duration of the r-TWT SP, a second trigger frame comprising the identifier of the STA. In other words, according to step 2308, when the first BSR indicates a non-empty buffer for the TID, the STA does not terminate (i.e., extends) the r-TWT SP at the expiration of the wake duration of the r-TWT SP and transmits the second trigger frame after expiration of the wake duration.

In an embodiment, the first BSR may indicate a non-empty buffer for the TID. Process 2300 may further include transmitting, by the AP to the STA, after expiration of the wake duration of the r-TWT SP, the second trigger frame comprising the identifier of the STA. In an embodiment, process 2300 may further include receiving, by the AP from the STA, in response to the second trigger frame, a second data frame comprising a second BSR for the TID associated with the r-TWT.

In an embodiment, process 2300 may further include on condition of the second BSR indicating an empty buffer for the TID, transmitting, by the AP to the STA, a frame having an EOSP field set to 1. The frame may include an MSDU, an A-MSDU, or a QoS Null frame.

In an embodiment, process 2300 may further include transmitting, by the AP to the STA, during the r-TWT SP, a second frame comprising a TID of the one or more TIDs associated with the r-TWT. In an embodiment, a value of an EOSP field of the second frame is set based on presence of buffered bufferable units (BUs) for the one or more TIDs associated with the r-TWT. The buffered BUs may include downlink DUs and/or uplink BUs. The second frame may include an MSDU, an A-MSDU, or a QoS Null frame.

In an embodiment, the value of the EOSP field of the second frame is set to 0 when buffered BUs are present for the one or more TIDs associated with the r-TWT. In an embodiment, the value of the EOSP field of the second frame is set to 1 when buffered BUs are not present for the one or more TIDs associated with the r-TWT.

In an embodiment, where the value of the EOSP field of the second frame is set to indicate presence of buffered BUs for the one or more TIDs associated with the r-TWT, process 2300 may further include transmitting, by the AP to the STA, after expiration of the wake duration of the r-TWT SP, a third frame comprising a TID of the one or more TIDs associated with the r-TWT. An EOSP field of the third frame may be set to 0 or 1. The third frame may include an MSDU, an A-MSDU, or a QoS Null frame.

In an embodiment, process 2300 may further include, for example before step 2302, receiving, by the AP from the STA, an association request frame comprising an indication regarding support of r-TWT SP extension by the STA.

In an embodiment, process 2300 may further include, for example before step 2302, transmitting, by the AP to the STA, an association response frame comprising an indication regarding support of r-TWT SP extension by the AP.

In an embodiment, where the STA supports r-TWT extension, process 2300 may further include, for example before step 2302, receiving, by the AP from the STA, an r-TWT setup request frame comprising an indication regarding r-TWT SP extension. The indication regarding r-TWT SP extension includes the STA's preference regarding the use or not of r-TWT extension for the r-TWT setup for the STA.

In an embodiment, where the AP supports r-TWT extension, process 2300 may further include, for example before step 2302, transmitting, by the AP to the STA, an r-TWT setup response frame comprising an indication regarding r-TWT SP extension. The indication regarding r-TWT SP extension includes the AP's decision regarding the use or not of r-TWT extension for the r-TWT setup for the STA. When r-TWT extension is used, the AP may operate in accordance with the above-described embodiments of process 2300.

In an embodiment, the indication regarding r-TWT SP extension may be comprised in a Restricted TWT Traffic Info field of a Broadcast TWT Parameter Set field comprised in the r-TWT setup request and/or the r-TWT setup response frame. In an embodiment, the indication regarding r-TWT SP extension may be comprised in a Traffic Info Control field of the Restricted TWT Traffic Info field.

According to embodiments, unless modified otherwise by embodiments of the present disclosure as discussed herein, a TWT scheduling AP and a TWT scheduled STA may follow rules as defined in the IEEE 802.11 standard draft “IEEE P802.11-REVme™/D1.2, April 2022.” For example, among other sections, a TWT scheduling AP may follow the rules defined in section 26.8.3.2 (Rules for TWT scheduling AP) of the IEEE 802.11 standard draft “IEEE P802.11-REVme™/D1.2, April 2022.”. Among other sections, a TWT scheduled STA may follow the rules defined in section 26.8.3.3 (Rules for TWT scheduled STA) and 26.8.5 (Power save operation during TWT SPs) of the IEEE 802.11 standard draft “IEEE P802.11-REVme™/D1.2, April 2022.”

According to the rules defined in section 26.8.3.2:

A TWT scheduling AP that receives a PS-Poll or a U-APSD trigger frame or any other indication from a TWT scheduled STA in PS mode, during or before a specific announced TWT SP but after the end of the most recent TWT SP preceding the specific TWT SP (if any), that the TWT scheduled STA is in the awake state during the TWT SP shall follow the rules defined in 11.2.3.6 (AP operation), except that the AP should deliver to the TWT scheduled STA as many buffered BUs as are available at the AP, provided that the BU delivery does not exceed the duration of the TWT SP, the TWT scheduled STA has indicated that it is in the awake state for that TWT SP, and the TWT scheduled STA has not entered the doze state (see 26.8.4.3 (TWT Information frame exchange for broadcast TWT) and 26.8.5 (Power save operation during TWT SPs)).

A TWT scheduling AP that sends frames to a TWT scheduled STA that is in PS mode during an unannounced TWT SP shall follow the rules defined in 11.2.3.6 (AP operation), except that the AP should deliver to the TWT scheduled STA as many buffered BUs as available at the AP, provided that the BU delivery does not exceed the duration of the TWT SP and the TWT scheduled STA has not entered the doze state (see 26.8.4.3 (TWT Information frame exchange for broadcast TWT) and 26.8.5 (Power save operation during TWT SPs)). NOTE 7—The TWT scheduling AP can deliver the buffered BUs in A-MPDUs sent under a BlockAck agreement if the TWT is an announced TWT and the TWT scheduled STA is awake for that TWT SP or if the TWT is an unannounced TWT (at the start of which the TWT scheduled STA is assumed to already be awake). The buffered BUs can be delivered in multiple PPDUs transmitted within the TWT SP. The TWT scheduling AP can exceed the duration of the TWT SP if the TWT scheduled STA is in active mode.

According to the rules defined in section 26.8.3.3:

A TWT scheduled STA should not transmit frames to the TWT scheduling AP outside of broadcast TWT SPs and should not transmit frames that are not contained within HE TB PPDUs to the TWT scheduling AP within trigger-enabled broadcast TWT SPs, except that the STA can transmit frames within negotiated individual TWT SPs as defined in 26.8.2 (Individual TWT agreements). NOTE 1—The TWT scheduled STA decides which frames to transmit within or outside a TWT SP; and while it is recommended that the TWT scheduled STA not transmit using EDCA within or outside TWT SPs, the TWT scheduled STA might still do so. If the STA decides to transmit, then the STA might contend for accessing the medium as defined in 10.23.2 (HCF contention-based channel access (EDCA)) and in 26.2.7 (EDCA operation using MU EDCA parameters).

According to the rules defined in section 26.8.5:

A TWT requesting STA or a TWT scheduled STA that is not in PS mode and that transmits a frame with the Power Management subfield set to 1 during a TWT SP shall remain in the awake state until the AdjustedMinimumTWTWakeDuration time has elapsed from the TWT SP start time or until a TWT SP termination event is detected, whichever occurs first for that particular TWT SP.

A TWT requesting STA or a TWT scheduled STA in PS mode that is in the awake state for a TWT SP may transition to the doze state after AdjustedMinimumTWTWakeDuration time has elapsed from the TWT SP start time even if it has previously transmitted a PS-Poll frame or U-APSD trigger frame and has not yet received the expected frames from the AP in response. For a trigger-enabled TWT SP, if the AdjustedMinimumTWTWakeDuration time has elapsed from the scheduled TWT SP start time and no Trigger frames are received by the STA, the HE STA may enter doze state if no other condition requires the STA to remain awake. When a TWT SP termination event is detected within a TWT SP by a STA in PS mode that is participating in the TWT SP, the STA may transition to the doze state without waiting for the expiration of the AdjustedMinimumTWTWakeDuration time as described in 10.47.1 (TWT overview), even if it has previously transmitted a PS-Poll frame or U-APSD trigger frame and has not yet received the expected frames from the AP in response.

A TWT requesting STA or a TWT scheduled STA shall classify any of the following events as a TWT SP termination event:
a) The transmission by the TWT requesting STA of an acknowledgment in response to an individually addressed QoS Data or QoS Null frame sent by the TWT responding STA that had the EOSP subfield equal to 1.
b) The transmission by the TWT scheduled STA of an acknowledgment in response to an individually addressed QoS Data or QoS Null frame sent by the TWT scheduling AP that had the EOSP subfield equal to 1.
c) The transmission by the TWT requesting STA of an acknowledgment in response to an individually addressed frame that is neither a QoS Data frame nor a QoS Null frame, but that was sent by the TWT responding STA with the More Data field equal to 0.
d) The transmission by the TWT scheduled STA of an acknowledgment in response to an individually addressed frame that is neither a QoS Data frame nor a QoS Null frame, but that was sent by the TWT scheduling AP with the More Data field equal to 0.
c) The reception of an individually addressed or broadcast QoS Data or QoS Null frame sent by the TWT responding STA or TWT scheduling AP that does not solicit an immediate response and had the EOSP subfield equal to 1.
f) The reception of an individually addressed frame that is neither a QoS Data frame nor a QoS Null frame, but that was sent by the TWT responding STA or TWT scheduling AP, does not solicit an immediate response, and had the More Data field equal to 0.
g) The reception of a Trigger frame sent by the TWT responding STA or TWT scheduling AP that has the More TF field equal to 0 and is not addressed to the TWT requesting STA or TWT scheduled STA, provided that the TWT requesting STA or TWT scheduled STA either is awake for an announced trigger-enabled TWT SP but did not transmit an indication that it is in the awake state to the TWT responding STA or TWT scheduling AP or is awake for an unannounced trigger-enabled TWT SP.
h) The transmission or reception by the TWT requesting STA of the acknowledgment for a TWT Information frame that satisfies specific conditions in 26.8.4.2 (TWT Information frame exchange for individual TWT) and 26.8.4.4 (TWT Information frame exchange for flexible wake time).
i) The transmission or reception by the TWT scheduled STA of the acknowledgment for a TWT Information frame that satisfies specific conditions in 26.8.4.3 (TWT Information frame exchange for broadcast TWT) and 26.8.4.4 (TWT Information frame exchange for flexible wake time).

1. A station (STA) comprising:
one or more processors; and
memory storing instructions that, when executed by the one or more processors, cause the STA to:
transition to an awake state at or before a start time of a restricted target wake time (r-TWT) service period (SP) of an r-TWT setup for the STA by an access point (AP);
receive, from the AP, during the r-TWT SP:
a first frame comprising a traffic identifier (TID) associated with the r-TWT and having an end of service period (EOSP) field set to 0; or
a trigger frame indicating an identifier of the STA; and
transition to a doze state, after expiration of a wake duration of the r-TWT SP, on condition of receiving, from the AP, after expiration of the wake duration of the r-TWT SP, a second frame comprising a TID associated with the r-TWT and having an EOSP field set to 1.

2. The STA of claim 1, wherein the instructions, when executed by the one or more processors, further cause the STA to remain in the awake state, beyond the expiration of the wake duration of the r-TWT SP, on condition of not receiving, from the AP, during the r-TWT SP, a frame comprising a TID associated with the r-TWT and having an EOSP field set to 1.

3. The STA of claim 1, wherein the instructions, when executed by the one or more processors, further cause the STA to receive a frame, from the AP, after the expiration of the wake duration of the r-TWT SP.

4. The STA of claim 3, wherein the frame comprises the second frame comprising a TID associated with the r-TWT and having an EOSP field set to 1, and wherein the instructions, when executed by the one or more processors, cause the STA to transition to the doze state based on the EOSP field of the second frame being set to 1.

5. The STA of claim 1, wherein the instructions, when executed by the one or more processors, further cause the STA to transition to the doze state, before or at expiration of the wake duration of the r-TWT SP, on condition of receiving, from the AP, during the r-TWT SP, a frame having an EOSP field set to 1.

6. The STA of claim 5, wherein a “More Data” field of the frame, received during the r-TWT SP and having an EOSP field set to 1, is set to 0 or 1.

7. The STA of claim 6, wherein the “More Data” field of the frame, received during the r-TWT SP and having an EOSP field set to 1, is set to 1, and wherein the instructions, when executed by the one or more processors, further cause the STA to:
transition to the doze state, during the r-TWT SP, based on receiving, from the AP, during the r-TWT SP, the frame having an EOSP field set to 1;
transition to the awake state at or before a start time of a subsequent r-TWT SP of the r-TWT setup for the STA; and
receive, during the subsequent r-TWT SP, a further frame comprising a TID not associated with the r-TWT.

8. The STA of claim 1, wherein the second frame is comprised in an A-MPDU, and wherein the instructions, when executed by the one or more processors, cause the STA to transition to the doze state on condition of acknowledging at least one MPDU comprised in the A-MPDU.

9. The STA of claim 1, wherein the second frame is comprised in an A-MPDU, and wherein the instructions, when executed by the one or more processors, cause the STA to transition to the doze state on condition of acknowledging all MPDUs comprised in the A-MPDU.

10. An access point (AP) comprising:
one or more processors; and
memory storing instructions that, when executed by the one or more processors, cause the AP to:
transmit to a station (STA) a frame indicating a start time and a wake duration of a restricted target wake time (r-TWT) service period (SP) of an r-TWT setup for the STA;
transmit to the STA, during the r-TWT SP, a first trigger frame comprising an identifier of the STA;
receive from the STA, in response to the first trigger frame, a first data frame comprising a first buffer status report (BSR) for a traffic identifier (TID) associated with the r-TWT; and
on condition of the first BSR indicating a non-empty buffer for the TID, transmit to the STA, after expiration of the wake duration of the r-TWT SP, a second trigger frame comprising the identifier of the STA.

11. The AP of claim 10, wherein the first BSR indicates a non-empty buffer for the TID, and wherein the instructions, when executed by the one or more processors, further cause the AP to transmit to the STA, after expiration of the wake duration of the r-TWT SP, the second trigger frame comprising the identifier of the STA.

12. The AP of claim 11, wherein the instructions, when executed by the one or more processors, further cause the AP to receive from the STA, in response to the second trigger frame, a second data frame comprising a second BSR for the TID associated with the r-TWT.

13. The AP of claim 12, wherein the instructions, when executed by the one or more processors, further cause the AP, on condition of the second BSR indicating an empty buffer for the TID, to transmit to the STA a frame having an end of service period (EOSP) field set to 1.

14. The AP of claim 13, wherein the frame having an EOSP field set to 1 comprises a medium access control (MAC) service data unit (MSDU), an aggregated MSDU (A-MSDU), or a Quality of Service (QOS) Null frame.

15. The AP of claim 10, wherein the instructions, when executed by the one or more processors, further cause the AP to transmit to the STA, during the r-TWT SP, a second frame comprising a TID of one or more TIDs associated with the r-TWT, wherein a value of an end of service period (EOSP) field of the second frame is set based on presence of buffered bufferable units (BUs) for the one or more TIDs associated with the r-TWT.

16. The AP of claim 15, wherein the second frame comprises a medium access control (MAC) service data unit (MSDU), an aggregated MSDU (A-MSDU), or a QoS Null frame.

17. The AP of claim 15, wherein the value of the EOSP field of the second frame is set to indicate presence of buffered BUs for the one or more TIDs associated with the r-TWT, and wherein the instructions, when executed by the one or more processors, further cause the AP to transmit to the STA, after expiration of the wake duration of the r-TWT SP, a third frame comprising a TID of the one or more TIDs associated with the r-TWT.

18. The AP of claim 17, wherein an EOSP field of the third frame is set to 0 or 1.

19. A non-transitory computer-readable medium comprising instructions that, when executed by one or more processors of a station (STA), cause the STA to:
transition to an awake state at or before a start time of a restricted target wake time (r-TWT) service period (SP) of an r-TWT setup for the STA by an access point (AP);
receive, from the AP, during the r-TWT SP:
a first frame comprising a traffic identifier (TID) associated with the r-TWT and having an end of service period (EOSP) field set to 0; or
a trigger frame indicating an identifier of the STA; and
transition to a doze state, after expiration of a wake duration of the r-TWT SP, on condition of receiving, from the AP, after expiration of the wake duration of the r-TWT SP, a second frame comprising a TID associated with the r-TWT and having an EOSP field set to 1.

20. The non-transitory computer-readable medium of claim 19, wherein the instructions, when executed by the one or more processors, further cause the STA to remain in the awake state, beyond the expiration of the wake duration of the r-TWT SP, on condition of not receiving, from the AP, during the r-TWT SP, a frame comprising a TID associated with the r-TWT and having an EOSP field set to 1.
